(19) United States
(12) Patent Application Publication
(10) Pub. No.: US 2023/0112173 A1
(43) Pub. Date: Apr. 13, 2023

(54) COMPOSITIONS, METHODS, AND SYSTEMS FOR CEMENT BLENDS WITH REACTIVE VATERITE

(71) Applicant: Arelac, Inc., San Jose, CA (US)

(72) Inventors: Craig Hargis, Campbell, CA (US); Hamed Maraghechi, Saratoga, CA (US); Ryan J Gilliam, San Jose, CA (US)

(21) Appl. No.: 17/963,647

(22) Filed: Oct. 11, 2022

Related U.S. Application Data
(60) Provisional application No. 63/254,844, filed on Oct. 12, 2021.

(51) Int. Cl. C04B 28/14; C04B 28/04; C04B 14/28; C04B 14/10; C04B 22/08; C04B 22/14; C04B 22/06; C04B 22/10; C04B 7/345; C04B 2/10

(52) U.S. Cl. CPC C04B 28/14; C04B 28/04; C04B 14/28; C04B 14/106; C04B 22/085; C04B 22/143; C04B 22/147; C04B 22/062; C04B 22/10; C04B 7/345; C04B 2/10; C04B 2103/10

(57) ABSTRACT

Provided herein are compositions, methods, and systems related to cement blend composition comprising reactive vaterite cement and supplementary cementitious material (SCM) comprising aluminosilicate material.

### CROSS-REFERENCE TO RELATED APPLICATIONS

This application claims benefit of U.S. Provisional Application No. 63/254,844 filed Oct. 12, 2021, which is incorporated herein by reference in its entirety in the present disclosure.

### BACKGROUND

Carbon dioxide (CO₂) emissions have been identified as a major contributor to the phenomenon of global warming. CO₂ is a by-product of combustion, and it creates operational, economic, and environmental problems. It may be expected that elevated atmospheric concentrations of CO₂ and other greenhouse gases can facilitate greater storage of heat within the atmosphere leading to enhanced surface temperatures and rapid climate change. In addition, elevated levels of CO₂ in the atmosphere may also further acidify the world's oceans due to the dissolution of CO₂ and formation of carbonic acid. Reducing potential risks of climate change requires sequestration and avoidance of CO₂ from various anthropogenic processes.

Concrete may be the second most consumed product on earth behind water and cement production may account for up to 8% of world's CO₂ emissions. Portland cement clinker may be produced through the reaction of limestone with siliceous, aluminous, and ferrous raw materials at 1450-1500° C. in a rotary kiln. The energy consumption needed to heat the material to this high temperature combined with the chemical decomposition of the limestone which liberates CO₂ to the atmosphere may result in an emission of typically 0.8 kg CO₂ per kg clinker produced. It is estimated that the global cement production in 2050 may be more than double the 2010 level. Therefore, there is an urgent need to reducing the CO₂ emissions associated with the production of the Portland cement clinker.

### SUMMARY

Provided herein are compositions, methods, and systems that either replace completely or replace a part of the Portland cement clinker with a reactive vaterite composition that not only reduces the CO₂ emissions but also provides equivalent or superior cementitious properties. Provided also herein are compositions, methods, and systems related to the reactive vaterite cement combined with supplementary cementitious material (SCM) such as, but not limited to, aluminosilicate material to provide reactive vaterite cements with superior cementitious properties.

In one aspect, there is provided a cement blend composition, comprising: reactive vaterite cement and supplementary cementitious material (SCM) comprising aluminosilicate material. In some embodiments of the foregoing aspect, the composition is a cement paste or cement slurry composition further comprising aragonite cement, calcite, carboaluminate hydrate, water, or combination thereof.

In one aspect, there is provided a dry cement blend composition, comprising: reactive vaterite cement and supplementary cementitious material (SCM) comprising aluminosilicate material. In one aspect, there is provided a cement paste or cement slurry composition, comprising: reactive vaterite cement, aragonite cement, calcite, carboaluminate hydrate, water, SCM comprising aluminosilicate material, or combination thereof.

In some embodiments of the foregoing aspects, the reactive vaterite cement has a specific surface area of between about 100-10,000 m²/kg. In some embodiments of the foregoing aspects and embodiments, the reactive vaterite cement has spherical particle shape having an average particle size of between about 0.1-100 μm. In some embodiments of the foregoing aspects and embodiments, the reactive vaterite cement has a specific surface area of between about 100-10,000 m²/kg; the reactive vaterite cement has spherical particle shape having an average particle size of between about 0.1-100 μm; and/or the reactive vaterite cement further comprises magnesium oxide. In some embodiments of the foregoing aspects and embodiments, the reactive vaterite cement has more than two times solubility of limestone in water. In some embodiments of the foregoing aspects and embodiments, the reactive vaterite cement reacts with the aluminosilicate material to form carboaluminate hydrate comprising monocarboaluminate, hemicarboaluminate, or combination thereof. In some embodiments of the foregoing aspects and embodiments, the reactive vaterite cement further comprises magnesium oxide. In some embodiments of the foregoing aspects and embodiments, the aluminosilicate material comprises heat-treated clay, natural or artificial pozzolan, shale, granulated blast furnace slag, or combination thereof. In some embodiments of the foregoing aspects and embodiments, the heat-treated clay comprises calcined clay, aluminosilicate glass, calcium aluminosilicate glass, or combination thereof. In some embodiments of the foregoing aspects and embodiments, the SCM further comprises untreated clay material. In some embodiments of the foregoing aspects and embodiments, the heat-treated clay is obtained from clay material or from the untreated clay material belonging to mineral selected from the group consisting of kaolin group, illite group, chlorite group, smectite group, vermiculite group, or mixture thereof. In some embodiments of the foregoing aspects and embodiments, the heat-treated clay is obtained from the clay and/or from the untreated clay belonging to the mineral of the kaolin group. In some embodiments of the foregoing aspects and embodiments, the kaolin group comprises kaolinite, dickite, nacrite, halloysite, or mixture thereof. In some embodiments of the foregoing aspects and embodiments, the smectite group comprises dioctahedral smectite, trioctahedral smectite, or mixture thereof. In some embodiments of the foregoing aspects and embodiments, the dioctahedral smectite comprises montmorillonite and/or nontronite and/or the trioctahedral smectite comprises saponite. In some embodiments of the foregoing aspects and embodiments, the heat-treated clay comprises material that predominately passes a 45 μm sieve. In some embodiments of the foregoing aspects and embodiments, the heat-treated clay comprises more than 0.5% by weight of the material that passes a 45 μm sieve. In some embodiments of the foregoing aspects and embodiments, the pozzolan is selected from the group consisting of fly ash, volcanic ash, or mixture thereof. In some embodiments of the foregoing aspects and embodiments, the composition further comprises Portland cement clinker. In some embodiments of the foregoing aspects and embodiments, the Portland cement clinker is ground to a specific surface area of 150-1,000 m²/kg. In some embodiments of the foregoing aspects and embodiments, the composition further comprises between 5-75% by weight of Portland cement clinker. In some embodiments of the foregoing aspects and embodiments, the SCM further comprises a carbonate material comprising limestone, calcium carbonate, magnesium carbonate, calcium magnesium carbonate, or combination thereof. In some embodiments of the foregoing aspects and embodiments, the limestone is heat-treated limestone. In some embodiments of the foregoing aspects and embodiments, the limestone or the heat-treated limestone is ground to a specific surface area of 100-5,000 m²/kg. In some embodiments of the foregoing aspects and embodiments, the composition further comprises calcium sulfate. In some embodiments of the foregoing aspects and embodiments, the composition further comprises alkali metal accelerator and/or an alkaline earth metal accelerator. In some embodiments of the foregoing aspects and embodiments, the alkali metal accelerator or the alkaline earth metal accelerator is selected from sodium sulfate, sodium carbonate, sodium nitrate, potassium sulfate, potassium carbonate, potassium nitrate, lithium sulfate, lithium carbonate, lithium nitrate, calcium sulfate, calcium nitrate, strontium sulfate, strontium carbonate, strontium nitrate, magnesium sulfate, magnesium carbonate, magnesium nitrate, potassium hydroxide, and combination thereof. In some embodiments of the foregoing aspects and embodiments, the weight ratio of the aluminosilicate material to the carbonate material is between about 0.1:1 to 10:1. In some embodiments of the foregoing aspects and embodiments, the weight ratio of the reactive vaterite cement to the SCM is between about 0.1:1 to 10:1. In some embodiments of the foregoing aspects and embodiments, the composition comprises by weight between about 10-50% reactive vaterite cement, between about 10-35% heat-treated clay, between about 0-10% limestone, and between about 15-90% Portland cement clinker. In some embodiments of the foregoing aspects and embodiments, the composition comprises by weight between about 10-50% reactive vaterite cement and between about 10-35% aluminosilicate material comprising heat-treated clay, and further comprising between about 0-10% limestone, and between about 15-90% Portland cement clinker. In some embodiments of the foregoing aspects and embodiments, the composition further comprises between about 0.1-5% by weight gypsum. In some embodiments of the foregoing aspects and embodiments, the composition after setting and hardening has a 28-day compressive strength of at least 21 MPa. In some embodiments of the foregoing aspects and embodiments, the composition has a pH of between 10-14.

In one aspect there is provided a concrete mix comprising the composition of any one of the aforementioned aspects and embodiments.

In one aspect there is provided a cement product, comprising aragonite cement or calcite and carboaluminate hydrate. In some embodiments of the foregoing aspects and embodiments, the cement product further comprises magnesium hydroxide, Portland cement clinker, carbonate material, gypsum, alkali metal accelerator, or mixture thereof. In some embodiments of the foregoing aspects and embodiments, the cement product further comprises magnesium oxide.

In one aspect there is provided a method of producing a cement blend composition, comprising (i) producing a reactive vaterite cement composition; and (ii) blending a supplementary cementitious material (SCM) comprising aluminosilicate material with the reactive vaterite cement composition to produce a cement blend composition.

In some embodiments of the foregoing aspect, the method further comprises producing the reactive vaterite cement composition by (a) calcining limestone to form a mixture comprising lime and a gaseous stream comprising carbon dioxide; (b) dissolving the mixture comprising lime in a N-containing salt solution to produce an aqueous solution comprising calcium salt; and (c) treating the aqueous solution comprising calcium salt with the gaseous stream comprising carbon dioxide to form a composition comprising reactive vaterite cement.

In some embodiments of the foregoing aspect, the method further comprises producing the reactive vaterite cement composition by (a) calcining limestone to form a mixture comprising lime and a gaseous stream comprising carbon dioxide; (b) dissolving the mixture comprising lime in a N-containing salt solution to produce an aqueous solution comprising calcium salt, and a gaseous stream comprising ammonia; and (c) treating the aqueous solution comprising calcium salt with the gaseous stream comprising carbon dioxide and the gaseous stream comprising ammonia to form a composition comprising reactive vaterite cement.

In some embodiments of the foregoing aspect, the method further comprises producing the reactive vaterite cement composition by (a) dissolving limestone in a N-containing salt solution to produce an aqueous solution comprising calcium salt, and a gaseous stream comprising carbon dioxide; and (b) treating the aqueous solution comprising calcium salt with the gaseous stream comprising carbon dioxide to form a composition comprising reactive vaterite cement.

In some embodiments of the foregoing aspects and embodiments, the aluminosilicate material comprises heat-treated clay, natural or artificial pozzolan, shale, granulated blast furnace slag, or combination thereof. In some embodiments of the foregoing aspects and embodiments, the method further comprises heating a clay material at a temperature between 500-1100° C. to produce the heat-treated clay before the blending step (ii). In some embodiments of the foregoing aspects and embodiments, the method further comprises grinding the heat-treated clay.

In some embodiments of the foregoing aspects and embodiments, the method further comprises mixing a carbonate material with the aluminosilicate material before the blending step (ii). In some embodiments of the foregoing aspects and embodiments, the method further comprises grinding the carbonate material to a specific surface area of 100-3,000 m²/kg before the mixing.

In some embodiments of the foregoing aspects and embodiments, the method further comprises mixing Portland cement clinker with the aluminosilicate material before the blending step (ii).

In some embodiments of the foregoing aspects and embodiments, the method further comprises adding water to the cement blend composition and transforming the reactive vaterite cement to aragonite cement and/or calcite upon dissolution and re-precipitation in water.

In some embodiments of the foregoing aspects and embodiments, the reactive vaterite cement has more than two times the solubility of limestone in water.

In some embodiments of the foregoing aspects and embodiments, the method further comprises reacting the reactive vaterite cement with the aluminosilicate material to form carboaluminate hydrate comprising monocarboaluminate, hemicarboaluminate, or combination thereof.

In some embodiments of the foregoing aspects and embodiments, the reactive vaterite cement composition further comprises magnesium oxide which in presence of water transforms to magnesium hydroxide. In some embodiments of the foregoing aspects and embodiments, the method further comprises binding the aragonite and/or the calcite together with the magnesium hydroxide.

In some embodiments of the foregoing aspects and embodiments, the method further comprises forming the reactive vaterite cement composition with a pH of above 10.

In some embodiments of the foregoing aspects and embodiments, the method further comprises setting and hardening of the aragonite and/or the calcite and forming a cement product.

In some embodiments of the foregoing aspects and embodiments, the aluminosilicate material is calcined clay.

In some embodiments of the foregoing aspects and embodiments, the heat treatment or the calcination is carried out in shaft kiln, rotary kiln, fluid bed furnace, or electric kiln.

In one aspect, there is provided a product formed by the method according to the aforementioned aspect and the embodiments.

In one aspect, there is provided a system to form a composition, comprising:

(i) a calcining reactor configured to calcine limestone to form a mixture comprising lime and a gaseous stream comprising carbon dioxide;

(ii) a dissolution reactor operably connected to the calcination reactor configured for dissolving the mixture comprising lime in an aqueous N-containing salt solution to produce an aqueous solution comprising calcium salt;

(iii) a treatment reactor operably connected to the dissolution reactor configured for treating the aqueous solution comprising calcium salt with the gaseous stream comprising carbon dioxide to form a composition comprising reactive vaterite cement composition; and

(iv) a blending reactor operably connected to the treatment reactor configured for blending a supplementary cementitious material (SCM) comprising aluminosilicate material with the reactive vaterite cement composition to produce a cement blend composition.

### DRAWINGS

The features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 illustrates some embodiments of the blended compositions provided herein.

FIG. 2A illustrates some embodiments of the methods and systems provided herein employing calcination of the limestone.

FIG. 2B illustrates some embodiments of the methods and systems provided herein employing limestone directly.

FIG. 3A illustrates some embodiments of the methods and systems provided herein employing calcination of the limestone.

FIG. 3B illustrates some embodiments of the methods and systems provided herein employing limestone directly.

FIG. 4A illustrates some embodiments of the methods and systems provided herein employing calcination of the limestone.

FIG. 4B illustrates some embodiments of the methods and systems provided herein employing limestone directly.

FIG. 5 illustrates data exemplified in Example 1 herein, showing benefits of the substitution of the Portland limestone cement with the reactive vaterite cement and the calcined clay.

FIG. 6 illustrates data exemplified in Example 2 herein, showing benefits of the substitution of the ground calcium carbonate with the reactive vaterite cement in a cement blend.

FIG. 7 illustrates data exemplified in Example 2 herein, showing benefits of the substitution of the ground calcium carbonate with the reactive vaterite cement in a cement blend.

FIG. 8 illustrates some embodiments of an overall process and composition of the reactive vaterite cement from lime feedstock.

### DESCRIPTION

Provided herein are compositions, methods, and systems related to the reactive vaterite cement combined with the SCM such as, but not limited to, aluminosilicate material to provide the reactive vaterite cement with superior cementitious properties. Also provided herein are the compositions, methods, and systems that either replace completely or replace a part of the Portland cement clinker with the reactive vaterite composition to form various cement blends with superior cementitious properties, such as, but not limited to, early and high compressive strengths, low CO₂ emissions, and high overall performance.

For example, traditionally, Portland cement clinker may be mixed with limestone and calcined clay to form limestone calcined clay cement blend. Applicants unexpectedly and surprisingly found that the reactive vaterite cement possessed more than two times the solubility in water than limestone resulting in faster kinetics of the cementation process. It was also found that the reactive vaterite cement reacted with the aluminosilicate material to form carboaluminate hydrate that resulted in better binding and higher compressive strength. The reactive vaterite cement also transformed to the aragonite and/or the calcite during the cementation process resulting in additional complex network in the cement product, further adding to the compressive strength. In some embodiments, the reactive vaterite cement further comprises magnesium oxide which after hydration forms the magnesium hydroxide that binds to the formed aragonitic cement and/or the calcite resulting in high durability and strength. The aforementioned unique features related to the synergistic effect of the combination of the reactive vaterite cement and the aluminosilicate materials optionally along with the Portland cement clinker and optionally the other SCM and additives provides unique cementitious compositions.

Various cement blend compositions and methods and systems to form those compositions have been provided herein.

### I. Compositions

In one aspect, there are provided cement blend compositions comprising the reactive vaterite cement and the SCM comprising aluminosilicate material. The blend composition can be dry or wet composition.

The “reactive vaterite” or “reactive vaterite cement” as used herein, includes vaterite material that transforms to aragonite and/or calcite during and/or after dissolution-re-precipitation process in water and sets and hardens into a cement. As used herein, “supplementary cementitious material” (SCM) includes the material that contributes to the properties of the cement or the cement blend. Various examples of the SCM have been provided herein.

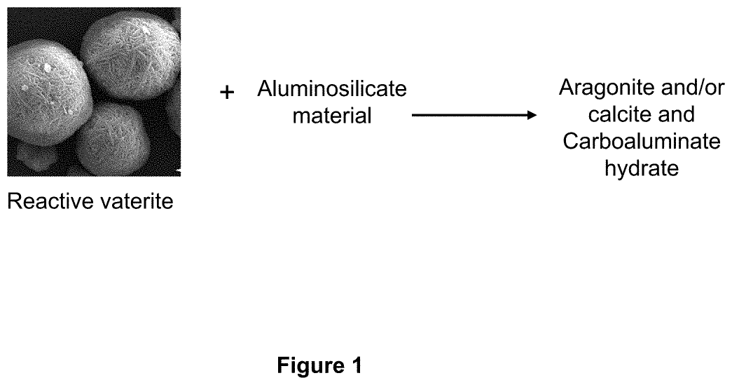

The aragonite and/or the calcite may impart one or more unique characteristics to the product including, but not limited to, high compressive strength, complex microstructure network and binding, etc. As illustrated in FIG. 1, the reactive vaterite cement with its unique morphology shows unexpected properties of forming bonds with the aluminosilicate material to form carboaluminate hydrate that impart high compressive strength to the cement product. During the dissolution-re-precipitation process of the reactive vaterite cement in water, transformation of the vaterite to the aragonite and/or the calcite takes place along with the formation of the carboaluminate hydrate. Accordingly, in one aspect, there is provided cement paste or cement slurry composition comprising reactive vaterite cement, aragonite cement, calcite, carboaluminate hydrate, water, SCM comprising aluminosilicate material, or combination thereof. In one aspect, there is provided cement paste or cement slurry composition comprising aragonite cement, calcite, carboaluminate hydrate, water, or combination thereof. The carboaluminate hydrate includes, but not limited to, monocarboaluminate, hemicarboaluminate, or combination thereof. The incorporation of the carboaluminate hydrate in the aragonite and/or the calcite network provides unique properties to the cement such as, but not limited to, high compressive strength, complex microstructure network and binding, etc.

As described further herein, in some embodiments, the reactive vaterite cement further comprises the magnesium oxide which after hydration forms the magnesium hydroxide that binds to the formed aragonitic cement and/or the calcite resulting in high durability and strength. In some embodiments, the magnesium hydroxide combined with carboaluminate hydrate formation, provides enhanced cementitious properties to the reactive vaterite cement blends. Accordingly, in one aspect, there is provided cement paste or cement slurry composition comprising reactive vaterite cement, aragonite cement, calcite, magnesium oxide, magnesium hydroxide, carboaluminate hydrate, water, SCM comprising aluminosilicate material, or combination thereof. In one aspect, there is provided cement paste or cement slurry composition comprising aragonite cement, calcite, magnesium hydroxide, carboaluminate hydrate, water, or combination thereof. In one aspect, there is provided cement paste or cement slurry composition comprising aragonite cement, calcite, magnesium oxide, magnesium hydroxide, carboaluminate hydrate, water, or combination thereof. Various other components that can be blended in the composition, such as but not limited to, Portland cement clinker, carbonate material, alkali metal accelerator, or alkaline earth metal accelerator etc. have been all described herein.

Incorporating the magnesium oxide (e.g., periclase) into the reactive vaterite composition may provide one or more of the following advantages. First, the magnesium oxide in the composition comprising the reactive vaterite can provide the magnesium ions to control the transformation of the reactive vaterite into the aragonite (preventing further transformation to the calcite) and/or to the calcite. Second, the magnesium oxide may chemically react with water to form the magnesium hydroxide. The bound water then may add to the hardened cement paste's volume, thereby reducing the cement paste's porosity. The decrease in porosity results in increase in strength, hardness, and durability. Third, the presence of the magnesium hydroxide may buffer the pH of the cement's pore solution to approximately more than 9, which may be sufficient to prevent mild steel reinforcement from actively corroding in the cement structures. Incorporation of the magnesium oxide in the reactive vaterite composition has been described in detail in U.S. Provisional Application No. 63/176,709, filed Apr. 19, 2021, which is incorporated herein by reference in its entirety.

In some embodiments of the foregoing aspects and embodiments, the reactive vaterite cement in the composition provided herein includes 50% w/w to 99% w/w reactive vaterite; or from 50% w/w to 95% w/w reactive vaterite; or from 50% w/w to 90% w/w reactive vaterite; or from 50% w/w to 75% w/w reactive vaterite; or from 60% w/w to 99% w/w reactive vaterite; or from 60% w/w to 95% w/w reactive vaterite; or from 60% w/w to 90% w/w reactive vaterite; or from 70% w/w to 99% w/w reactive vaterite; or from 70% w/w to 95% w/w reactive vaterite; or from 70% w/w to 90% w/w reactive vaterite; or from 80% w/w to 99% w/w reactive vaterite; or from 80% w/w to 95% w/w reactive vaterite; or from 80% w/w to 90% w/w reactive vaterite; or from 90% w/w to 99% w/w reactive vaterite; or 50% w/w reactive vaterite; or 60% w/w reactive vaterite; or 70% w/w reactive vaterite; or 75% w/w reactive vaterite; or 80% w/w reactive vaterite; or 85% w/w reactive vaterite; or 90% w/w reactive vaterite; or 95% w/w reactive vaterite; or 99% w/w reactive vaterite; or 100% w/w reactive vaterite. In some embodiments, the remaining amount in the foregoing amounts is other polymorphs of calcium carbonate, such as but not limited to the aragonite and/or the calcite. In some embodiments of the blended compositions provided herein, the reactive vaterite cement includes 99-99.9% reactive vaterite.

In some embodiments of the foregoing aspects and embodiments, the reactive vaterite cement has a specific surface area of between about 100-10,000 m²/kg; or between about 100-9,000 m²/kg; or between about 100-8,000 m²/kg; or between about 100-7,000 m²/kg; or between about 100-6,000 m²/kg; or between about 100-5,000 m²/kg; or between about 100-4,000 m²/kg; or between about 100-3,000 m²/kg; or between about 100-2,000 m²/kg; or between about 100-1,000 m²/kg; or between about 100-500 m²/kg; or between about 500-10,000 m²/kg; or between about 500-9,000 m²/kg; or between about 500-8,000 m²/kg; or between about 500-7,000 m²/kg; or between about 500-6,000 m²/kg; or between about 500-5,000 m²/kg; or between about 500-4,000 m²/kg; or between about 500-3,000 m²/kg; or between about 500-2,000 m²/kg; or between about 500-1,000 m²/kg; or between about 1,000-10,000 m²/kg; or between about 1,000-9,000 m²/kg; or between about 1,000-8,000 m²/kg; or between about 1,000-7,000 m²/kg; or between about 1,000-6,000 m²/kg; or between about 1,000-5,000 m²/kg; or between about 1,000-4,000 m²/kg; or between about 1,000-3,000 m²/kg; or between about 1,000-2,000 m²/kg; or between about 2,000-3,000 m²/kg; or between about 2,000-10,000 m²/kg; or between about 3,000-10,000 m²/kg; or between about 4,000-10,000 m²/kg; or between about 5,000-10,000 m²/kg; or between about 6,000-10,000 m²/kg; or between about 7,000-10,000 m²/kg; or between about 8,000-10,000 m²/kg.

In some embodiments of the blended composition provided herein, the reactive vaterite cement has spherical particle shape having an average particle size of between about 0.1-100 μm (micron). The average particle size (or average particle diameter) may be determined using any conventional particle size determination method, such as, but not limited to, multi-detector laser scattering or laser diffraction or sieving. In certain embodiments, unimodal or multimodal, e.g., bimodal or other, distributions are present. Bimodal distributions may allow the surface area to be minimized, thus allowing a lower liquids/solid mass ratio when composition is mixed with water yet providing smaller reactive particle for early reaction. In some embodiments, the reactive vaterite cement is a particulate composition with an average particle size of 0.1-100 micron; or 0.1-50 micron; or 0.1-20 micron; or 0.1-10 micron; or 0.1-5 micron; or 1-50 micron; or 1-25 micron; or 1-20 micron; or 1-10 micron; or 1-5 micron; or 5-70 micron; or 5-50 micron; or 5-20 micron; or 5-10 micron; or 10-100 micron; or 10-50 micron; or 10-20 micron; or 10-15 micron; or 15-50 micron; or 15-30 micron; or 15-20 micron; or 20-50 micron; or 20-30 micron; or 30-50 micron; or 40-50 micron; or 50-100 micron; or 50-60 micron; or 60-100 micron; or 60-70 micron; or 70-100 micron; or 70-80 micron; or 80-100 micron; or 80-90 micron; or 0.1 micron; or 0.5 micron; or 1 micron; or 2 micron; or 3 micron; or 4 micron; or 5 micron; or 8 micron; or 10 micron; or 15 micron; or 20 micron; or 30 micron; or 40 micron; or 50 micron; or 60 micron; or 70 micron; or 80 micron; or 100 micron. For example, in some embodiments, the reactive vaterite cement is a particulate composition with an average particle size of 0.1-20 micron; or 0.1-15 micron; or 0.1-10 micron; or 0.1-8 micron; or 0.1-5 micron; or 1-25 micron; or 1-20 micron; or 1-15 micron; or 1-10 micron; or 1-5 micron; or 5-20 micron; or 5-10 micron. In some embodiments, the reactive vaterite cement includes two or more, or three or more, or four or more, or five or more, or ten or more, or 20 or more, or 3-20, or 4-10 different sizes of the particles in the composition. For example, the composition may include two or more, or three or more, or between 3-20 particles ranging from 0.1-10 micron, 10-50 micron, 50-100 micron, and/or sub-micron sizes of the particles.

The “aluminosilicate material” as used herein includes any material that is rich in aluminate and silicate mineral. This material can be natural or man-made. In some embodiments of the foregoing aspects and embodiments, the aluminosilicate material comprises heat-treated clay, natural or artificial pozzolan, shale, granulated blast furnace slag, or combination thereof. In some embodiments of the foregoing aspects and embodiments, the natural or artificial pozzolan is selected from the group consisting of fly ash, volcanic ash, and mixture thereof. Pozzolan may be naturally available and comprise fine particles of siliceous and aluminous material that in presence of water may react with Ca ions in the reactive vaterite to form cementitious material.

Clay is a type of fine-grained natural soil material containing clay mineral. Clay may develop plasticity when wet, due to a molecular film of water surrounding the clay particle, but may become hard, brittle and non-plastic upon drying or firing. Shale, formed largely from clay, may be the common sedimentary rock. Although many naturally occurring deposits include both silts and clay, clay may be distinguished from other fine-grained soil by differences in size and mineralogy.

The clay material (or the untreated clay material) may belong to mineral selected from the group consisting of kaolin group, illite group, chlorite group, smectite group, vermiculite group, or mixture thereof. The main groups of clay may include, but not limited to, kaolinite, montmorillonite-smectite, and illite. Chlorite, vermiculite, talc, and pyrophyllite may sometimes be classified as clay mineral. There may be approximately 30 different types of pure clays in these categories, but natural clay deposits may be mixtures of these different types, along with other weathered minerals. Clay mineral in clays may be identified using X-ray diffraction. In some embodiments of the foregoing aspects and embodiments, the kaolin group may include, but not limited to, kaolinite, dickite, nacrite, halloysite, or mixture thereof. In some embodiments of the foregoing aspects and embodiments, the smectite group may include, but not limited to, dioctahedral smectite, trioctahedral smectite, or mixture thereof. In some embodiments of the foregoing aspects and embodiments, the dioctahedral smectite includes, but not limited to, montmorillonite and/or nontronite and/or the trioctahedral smectite includes, but not limited to, saponite.

Clay mineral or the heat-treated clay mineral may be hydrous aluminum phyllosilicate mineral, composed of aluminum and silicon ions bonded into tiny, thin plates by interconnecting oxygen and hydroxide ions. These plates may be tough but flexible, and in moist clay, they may adhere to each other. For example, in kaolinite clay, the bonding between plates may be provided by a film of water molecules that hydrogen bond the plates together. The bonds may be weak enough to allow the plates to slip past each other when the clay is being molded, but strong enough to hold the plates in place and allow the molded clay to retain its shape after it is molded. When the clay is dried, most of the water molecules may be removed, and the plates may hydrogen bond directly to each other, so that the dried clay may be rigid but still fragile. If the clay is moistened again, it may once more become plastic.

Without being limited by any theory, it is contemplated that during the dissolution-re-precipitation process of the reactive vaterite cement in water, transformation of the reactive vaterite to the aragonite and/or the calcite takes place along with the formation of the carboaluminate hydrate, which strengthen the cement material. Furthermore, the aluminosilicate material, such as for example only, the heat-treated clay material, such as, e.g., the calcined clay may dissolve in the basic pore solution of the cement paste, providing aluminate ions for carboaluminate hydrate and calcium aluminate silicate hydrate formation; and/or silicate ions for calcium silicate and calcium aluminate silicate hydrate formation.

In the embodiments provided herein, the clay material (or the untreated clay material) may be heat treated to form the heat-treated clay material. In some embodiments of the foregoing aspects and embodiments, the heat-treated clay is obtained from the clay or from the untreated clay belonging to the mineral of the kaolin group, illite group, chlorite group, smectite group, vermiculite group, or mixture thereof. In the embodiments provided herein, the clay material (or the untreated clay material) may be heat treated at 750-850° C. to form the heat-treated or the activated clay material. For example only, the calcined clay or the metakaolin may be produced by heating a source of kaolinite to between 650° C. and 750° C. The kaolin may be both naturally occurring, as in China clay deposits and some tropical soils, as well as in industrial by-products, such as some paper sludge waste and oil sands tailing.

The aforementioned clay material may be pozzolanic (or reactive) in raw state or untreated state and/or heat-treated state. Raw or untreated clay may have a moderate or low pozzolanic activity which may be increased by activation. The activation includes mechanical and/or thermal activation. As a result of the activation, the clay mineral may undergo processes of dehydroxylation and amorphisation and the accompanying change in coordination of Al ions. Those processes may lead to, among other things, greater solubility of Al and Si ions and their greater reactivity. The activation process may be carried out mechanically (e.g., by grinding) or thermally by heating to a temperature high enough to destroy the structure of the clay minerals, but low enough to avoid recrystallization and the formation of chemically inert phases. For example, the kaolinitic clay may be ground before it undergoes calcination, i.e., the activation may have both the mechanical and the thermal component.

In some embodiments of the foregoing aspects and embodiments, the heat-treated clay includes, but not limited to, calcined clay, aluminosilicate glass, calcium aluminosilicate glass, or combination thereof.

In some embodiments, the grinding and/or heating of the clay material may influence the particle size of the clay. In some embodiments of the foregoing aspects and embodiments, the heat-treated clay comprises material that predominately passes a 45 μm sieve. In some embodiments of the foregoing aspects and embodiments, the heat-treated clay comprises more than 0.5% by weight of the material that passes a 45 μm sieve; or more than 1% by weight of the material that passes a 45 μm sieve; or between 1-10% by weight of the material that passes a 45 μm sieve. In some embodiments of the foregoing aspects and embodiments, the heat-treated clay comprises more than 0.5% by weight of the clay material having median particle size of between about 5-10 micron; or between about 6-10 micron; or between about 7-10 micron; or between about 8-10 micron; or between about 9-10 micron.

In some embodiments of the foregoing aspects and embodiments, the blend composition comprising the reactive vaterite cement and the SCM comprising aluminosilicate material, further comprises carbonate material (described further herein). In some embodiments of the foregoing aspects and embodiments, the blend composition comprising the reactive vaterite cement and the SCM comprising aluminosilicate material, optionally further comprising the carbonate material, further comprises alkali metal or alkaline earth metal accelerator (described further herein).

In some embodiments of the foregoing aspects and embodiments, the blend composition further comprises Ordinary Portland cement (OPC) or Portland cement clinker. In some embodiments of the foregoing aspects and embodiments, Applicants unexpectedly and surprisingly found that the reactive vaterite cement may partially or completely substitute the Portland cement clinker in the limestone calcined clay cement.

The limestone calcined clay cement comprising the reactive vaterite cement provided herein, is a ternary binder system with lower CO₂ emission, made of the Portland cement clinker, the reactive vaterite cement, the aluminosilicate material, e.g., calcined clay, and optionally carbonate material e.g., limestone and/or gypsum. Typically, the limestone calcined clay cement is a blend of the Portland cement clinker, the traditional limestone, and the calcined clay, in which lower energy may be consumed in calcination as lower temperatures may be required for the calcination of the clay (750-850° C.) than that of the clinker (1450° C.) resulting in less CO₂ emissions. However, Portland cement production itself loses 44% by weight of the limestone feedstock as CO₂ emissions. Applicants found that the CO₂ emissions can be further reduced by partially or completely substituting the Portland cement clinker in the limestone calcined clay cement with the reactive vaterite cement. Similarly, in some embodiments, the limestone in the traditional limestone calcined clay cement blend may be partially or completely substituted with the reactive vaterite cement. In some embodiments, the aluminosilicate material, e.g., clay in the traditional limestone calcined clay cement blend may be partially or completely substituted with the reactive vaterite cement. Some unexpected and surprising results have been provided in the examples herein. Some or all of these substitutions with the reactive vaterite cement may be employed in order to form the compositions of the invention.

As explained above, due to the formation of the carboaluminate hydrate phases (e.g., monocarboaluminate hemi-carboaluminate and monocarboaluminate) between the reactive vaterite cement and the aluminosilicate material, such as e.g., clay, unique properties such as high compressive strength, faster cementation, durability, mechanical strength development, better chloride resistance, better sulfate resistance, lower gas permeability and capillary water absorption, early enhancement of durability parameters etc. are imparted to the reactive vaterite cement blend and/or the limestone calcined clay cement.

In some embodiments of the foregoing aspects and embodiments, the Portland cement clinker is ground to a specific surface area of 150-1000 m²/kg; or between 150-500 m²/kg; or between 150-200 m²/kg; or between 100-150 m²/kg; or between 200-500 m²/kg. In some embodiments of the foregoing aspects and embodiments, the composition comprising the reactive vaterite cement and the SCM comprising aluminosilicate material, and optionally limestone and/or alkali metal or alkaline earth metal accelerator (described further herein) further comprises between 5-90% by weight of the Portland cement clinker; or between 5-80% by weight; or between 5-70% by weight; or between 5-60% by weight; or between 5-50% by weight; or between 5-40% by weight; or between 5-30% by weight; or between 5-20% by weight; or between 5-10% by weight; or between 10-90% by weight; or between 10-80% by weight; or between 10-70% by weight; or between 10-60% by weight; or between 10-50% by weight; or between 10-40% by weight; or between 10-30% by weight; or between 10-20% by weight; or between 20-90% by weight; or between 20-80% by weight; or between 20-70% by weight; or between 20-60% by weight; or between 20-50% by weight; or between 20-40% by weight; or between 20-30% by weight; or between 30-90% by weight; or between 30-80% by weight; or between 30-70% by weight; or between 30-60% by weight; or between 30-50% by weight; or between 30-40% by weight; or between 40-90% by weight; or between 40-80% by weight; or between 40-70% by weight; or between 40-60% by weight; or between 40-50% by weight; or between 50-90% by weight; or between 50-80% by weight; or between 50-70% by weight; or between 50-60% by weight; or between 60-90% by weight; or between 60-80% by weight; or between 60-70% by weight; or between 70-90% by weight; or between 70-80% by weight; or between 80-90% by weight of the Portland cement clinker.

In some embodiments of the blended compositions provided herein, the SCM in the composition further comprises the carbonate material comprising limestone, calcium carbonate, magnesium carbonate, calcium magnesium carbonate, or combination thereof. Various forms of the limestone have been described herein. The limestone also serves as a feedstock to produce the reactive vaterite cement, as described further herein.

In some embodiments of the blended compositions provided herein, the reactive vaterite cement partially or completely substitutes the Portland cement clinker in the limestone calcined clay cement and/or partially or completely substitutes the limestone or the ground calcium carbonate (GCC) in the limestone calcined clay cement. Typically, use of the limestone or the GCC in the limestone calcined clay cement suffers from several disadvantages, including, but not limited to, low solubility and slow reaction; energy intensive process of grinding the limestone to fine size; and/or co-grounding of the limestone with the clinker resulting in slowing the grinding mills down and increasing the energy demand.

Applicants unexpectedly and surprisingly found that the combination of the carbonate material, e.g., the limestone with the reactive vaterite cement in the blend composition and/or the substitution of the carbonate material, e.g., the limestone with the reactive vaterite cement in the limestone calcined clay cement composition provided herein, results in higher solubility of the vaterite and faster reaction, early strength development, and high compressive strength of the cement products. Some unexpected and surprising results have been provided in the examples herein.

In some embodiments of the foregoing aspects and embodiments, the limestone is heat-treated limestone. The heat-treated limestone may be produced by calcining the limestone to high temperatures. In some embodiments, the limestone may be calcined in a same calciner as the calciner for Portland cement clinker and/or the calciner for the aluminosilicate material and/or calciner used in the process to produce the reactive vaterite cement.

In some embodiments of the foregoing aspects and embodiments, the limestone or the heat-treated limestone is ground to a specific surface area of between about 100-5,000 m²/kg; or between about 100-4,000 m²/kg; or between about 100-3,000 m²/kg; or between about 100-2,000 m²/kg; or between about 100-1,000 m²/kg; or between about 100-500 m²/kg; or between about 500-5,000 m²/kg; or between about 500-4,000 m²/kg; or between about 500-3,000 m²/kg; or between about 500-2,000 m²/kg; or between about 500-1,000 m²/kg; or between about 1,000-5,000 m²/kg; or between about 1,000-4,000 m²/kg; or between about 1,000-3,000 m²/kg; or between about 1,000-2,000 m²/kg; or between about 2,000-5,000 m²/kg; or between about 2,000-4,000 m²/kg; or between about 2,000-3,000 m²/kg; or between about 3,000-5,000 m²/kg; or between about 3,000-4,000 m²/kg; or between about 4,000-5,000 m²/kg.

In some embodiments of the blended composition provided herein, the blend composition (e.g., the blend composition comprising the reactive vaterite cement and the SCM such as, the aluminosilicate material and/or the carbonate material and/or the Portland cement clinker; and/or the limestone calcined clay cement) further comprises an alkali metal accelerator and/or an alkaline earth metal accelerator. In some embodiments, the alkali metal accelerator and/or the alkaline earth metal accelerator facilitates early development of strength in the cement. Applicants discovered that the use of the alkali metal accelerator and/or an alkaline earth metal accelerator in the blend composition increases the compressive strength of the blend cement composition, as shown in Example 3 herein.

The alkali metal accelerator and/or the alkaline earth metal accelerator includes, but not limited to any alkali metal salt or hydroxide and/or an alkaline earth metal salt or hydroxide, such as e.g., sodium sulfate, sodium carbonate, sodium nitrate, potassium sulfate, potassium carbonate, potassium nitrate, lithium sulfate, lithium carbonate, lithium nitrate, calcium sulfate (or gypsum), calcium nitrate, strontium sulfate, strontium carbonate, strontium nitrate, magnesium sulfate, magnesium carbonate, magnesium nitrate, potassium hydroxide (or oxide), and combination thereof.

In some embodiments of the blend compositions provided herein (e.g., the blend composition comprising the reactive vaterite cement and the SCM such as, the aluminosilicate material and/or the carbonate material and/or the Portland cement clinker; and/or the limestone calcined clay cement), the composition further comprises sodium sulfate, potassium sulfate, lithium sulfate, calcium sulfate, strontium sulfate, magnesium sulfate, or combination thereof.

In some embodiments of the blend compositions provided herein (e.g., the blend composition comprising the reactive vaterite cement and the SCM such as, the aluminosilicate material and/or the carbonate material and/or the Portland cement clinker; and/or the limestone calcined clay cement), the composition further comprises sodium carbonate, potassium carbonate, lithium carbonate, strontium carbonate, magnesium carbonate, or combination thereof.

In some embodiments of the blend compositions provided herein (e.g., the blend composition comprising the reactive vaterite cement and the SCM such as, the aluminosilicate material and/or the carbonate material and/or the Portland cement clinker; and/or the limestone calcined clay cement), the composition further comprises sodium nitrate, potassium nitrate, lithium nitrate, calcium nitrate, strontium nitrate, magnesium nitrate, or combination thereof.

In some embodiments of the blend compositions provided herein (e.g., the blend composition comprising the reactive vaterite cement and the SCM such as, the aluminosilicate material and/or the carbonate material and/or the Portland cement clinker; and/or the limestone calcined clay cement), the composition further comprises calcium nitrate, calcium sulfate, potassium hydroxide (or potassium oxide), sodium sulfate, sodium carbonate, sodium nitrate, sodium sulfate, or combination thereof.

In some embodiments of the blend compositions provided herein (e.g., the blend composition comprising the reactive vaterite cement and the SCM such as, the aluminosilicate material and/or the carbonate material and/or the Portland cement clinker; and/or the limestone calcined clay cement), the composition further comprises potassium hydroxide (or potassium oxide).

In some embodiments of the blend compositions provided herein (e.g., the blend composition comprising the reactive vaterite cement and the SCM such as, the aluminosilicate material and/or the carbonate material and/or the Portland cement clinker; and/or the limestone calcined clay cement), the composition further comprises calcium nitrate.

In some embodiments of the blend compositions provided herein (e.g., the blend composition comprising the reactive vaterite cement and the SCM such as, the aluminosilicate material and/or the carbonate material and/or the Portland cement clinker; and/or the limestone calcined clay cement), the composition further comprises calcium sulfate.

In some embodiments of the blend compositions provided herein (e.g., the blend composition comprising the reactive vaterite cement and the SCM such as, the aluminosilicate material and/or the carbonate material and/or the Portland cement clinker; and/or the limestone calcined clay cement), the composition further comprises sodium sulfate, lithium sulfate, lithium carbonate, and/or sodium carbonate.

In some embodiments of the blend compositions provided herein, the composition comprises between about 0.1-5% by weight alkali metal accelerator or alkaline earth metal accelerator, e.g., sodium sulfate, sodium carbonate, sodium nitrate, potassium sulfate, potassium carbonate, potassium nitrate, lithium sulfate, lithium carbonate, lithium nitrate, calcium sulfate (or gypsum), calcium nitrate, strontium sulfate, strontium carbonate, strontium nitrate, magnesium sulfate, magnesium carbonate, magnesium nitrate, potassium hydroxide (or oxide), or combination thereof; or between about 0.1-4% by weight; or between about 0.1-3% by weight; or between about 0.1-2% by weight; or between about 0.1-1% by weight; or between about 0.1-0.5% by weight; or between about 1-5% by weight; or between about 1-4% by weight; or between about 1-3% by weight; or between about 1-2% by weight; or between about 2-5% by weight; or between about 2-4% by weight; or between about 2-3% by weight; or between about 3-5% by weight; or between about 3-4% by weight; or between about 4-5% by weight.

Some of the examples of the blend compositions are provided in Table 1 below.

TABLE 1

| | | | SCM | | |
|---|---|---|---|---|---|
| | | OPC or | | | Alkali metal or |
| | Reactive | Portland | Aluminosilicate | Carbonate | alkaline earth |
| Composition | vaterite | cement clinker | material | material | metal accelerator |
| 1 | X | | X | | |
| 2 | X | X | | | |
| 3 | X | X | X | | |
| 4 | X | X | X | X | |
| 5 | X | X | X | X | X |
| 6 | X | X | X | | X |
| 7 | X | | X | X | |
| 8 | X | | X | | X |
| 9 | X | | X | X | X |

In some embodiments of the foregoing aspects and embodiments, the composition may include a blend of by weight about 75% OPC or Portland cement clinker and between about 1-25% reactive vaterite cement; or about 80% OPC or Portland cement clinker and between about 1-20% reactive vaterite cement; or about 85% OPC or Portland cement clinker and between about 1-15% reactive vaterite cement; or about 90% OPC or Portland cement clinker and between about 1-10% reactive vaterite cement; or about 95% OPC or Portland cement clinker and between about 1-5% reactive vaterite cement. In some embodiments of the foregoing aspects and embodiments, the remaining amount in the blend composition may include one or more of the aluminosilicate material, the carbonate material and/or the alkali metal or alkaline earth metal accelerator.

In some embodiments of the foregoing aspects and embodiments, weight ratio of the aluminosilicate material to the carbonate material in the blend composition provided herein is between about 0.1:1 to 10:1; or between about 1:1 to 10:1; or between about 5:1 to 10:1; or between about 8:1 to 10:1.

In some embodiments of the foregoing aspects and embodiments, weight ratio of the reactive vaterite cement to the SCM in the blend composition provided herein is between about 0.1:1 to 10:1; or between about 1:1 to 10:1; or between about 5:1 to 10:1; or between about 8:1 to 10:1.

In some embodiments of the blend composition provided herein, the composition comprises by weight between about 10-50% reactive vaterite cement, between about 10-35% aluminosilicate material, between about 0-10% carbonate material, and between about 15-90% Portland cement clinker. In some embodiments of the blend composition provided herein, the composition comprises by weight between about 10-50% reactive vaterite cement, between about 10-35% aluminosilicate material, between about 0-10% carbonate material, between about 15-90% Portland cement clinker, and between about 0.1-5% alkali metal or alkaline earth metal accelerator.

In some embodiments of the blend composition provided herein, the composition comprises by weight between about 10-50% reactive vaterite cement, between about 10-35% calcined clay, between about 0-10% limestone, and between about 15-90% Portland cement clinker. In some embodiments of the blend composition provided herein, the composition comprises by weight between about 10-50% reactive vaterite cement, between about 10-35% calcined clay, between about 0-10% limestone, between about 15-90% Portland cement clinker, and between about 0.1-5% gypsum or lithium carbonate.

In some embodiments of the blend composition provided herein, the composition comprises by weight between about 10-20% reactive vaterite cement, between about 10-25% calcined clay, between about 0-10% limestone, between about 25-55% Portland cement clinker, and between about 2-5% gypsum or lithium carbonate. In some embodiments of the blend composition provided herein, the composition comprises by weight between about 25-35% reactive vaterite cement, between about 25-35% calcined clay, between about 0-5% limestone, between about 25-35% Portland cement clinker, and between about 2-5% gypsum or lithium carbonate.

In some embodiments, the blend composition provided herein in wet or dried form may further include one or more plasticizers. Examples of plasticizers include, without limitation, polycarboxylate based superplasticizers, MasterGlenium 7920, MasterGlenium 7500, Fritz-Pak Supercizer PCE, sodium salt of poly(naphthalene sulfonic acid), Fritz-Pak Supercizer 5, and the like. The plasticizing agent may be either in the form of a dry powder that is blended into the blend composition, such as a dry polycarboxylate ether like Fritz Pak Supercizer PCE, or the plasticizing agent may be a component of the grinding aid used during the milling of the Portland cement clinker, such as Grace Tavero® HEA2®.

In some embodiments, the blend composition provided herein in wet or dried form may further include an aggregate. The aggregate may provide for mortars which include fine aggregate and concrete which also includes coarse aggregate. The fine aggregate may be material that may almost entirely pass through a Number 4 sieve (ASTM C 125 and ASTM C 33), such as silica sand. The coarse aggregate may be material that may be predominantly retained on a Number 4 sieve (ASTM C 125 and ASTM C 33), such as silica, quartz, crushed marble, glass sphere, granite, calcite, feldspar, alluvial sand, sand or any other durable aggregate, or mixture thereof. As such, the aggregate is used broadly to refer to several different types of both coarse and fine particulate material, including, but are not limited to, sand, gravel, crushed stone, slag, and recycled concrete. The amount and nature of the aggregate may vary widely. In some embodiments, the amount of aggregate may range from 5 to 75% w/w of the blend composition provided herein. In some embodiments, the aggregate is repurposed or reused concrete.

In some embodiments, the blend composition provided herein in wet or dried form, may further include one or more admixtures to impart one or more properties to the product including, but not limited to, strength, flexural strength, compressive strength, porosity, thermal conductivity, etc. The amount of admixture that is employed may vary depending on the nature of the admixture. In some embodiments, the amount of the one or more admixtures ranges from 0.1 to 10% w/w. Examples of the admixture include, but not limited to, set accelerator, set retarder, air-entraining agent, foaming agent, defoamer, alkali-reactivity reducer, bonding admixture, dispersant, coloring admixture, corrosion inhibitor, damp-proofing admixture, gas former, permeability reducer, pumping aid, shrinkage compensation admixture, fungicidal admixture, germicidal admixture, insecticidal admixture, rheology modifying agent, finely divided mineral admixture, pozzolan, aggregate, wetting agent, strength enhancing agent, water repellent, reinforced material such as fiber, and any other admixture. When using an admixture, the blend composition to which the admixture raw material is introduced, is mixed for sufficient time to cause the admixture raw material to be dispersed relatively uniformly throughout the composition.

Set accelerator may be used to accelerate the setting and early strength development of cement. Examples of set accelerator that may be used include, but not limited to, POZZOLITH® NC534, non-chloride type set accelerator and/or RHEOCRETE® CNI calcium nitrite-based corrosion inhibitor. Set retarding, also known as delayed-setting or hydration control, admixture may be used to retard, delay, or slow the rate of setting of cement. In some embodiments, the set retarder may also act as low-level water reducer and can also be used to entrain some air into product. The air entrainer includes any substance that will entrain air in the composition. Some air entrainer can also reduce the surface tension of a composition at low concentration. Air-entraining admixture may be used to purposely entrain microscopic air bubbles into the cement. Material used to achieve these desired effects can be selected from wood resin, natural resin, synthetic resin, sulfonated lignin, petroleum acid, proteinaceous material, fatty acid, resinous acid, alkylbenzene sulfonate, sulfonated hydrocarbon, vinsol resin, anionic surfactant, cationic surfactant, nonionic surfactant, natural rosin, synthetic rosin, an inorganic air entrainer, synthetic detergent, and their corresponding salt, and mixture thereof.

In some embodiments, the blend composition provided herein in wet or dried form may further include foaming agent. The foaming agent may incorporate large quantities of air voids/porosity and facilitate reduction of the material's density. Examples of foaming agent include, but not limited to, soap, detergent (alkyl ether sulfate), Millifoam™ (alkyl ether sulfate), Cedepal™ (ammonium alkyl ethoxy sulfate), Witcolate™ 12760, and the like.

In some embodiments, the blend composition provided herein in wet or dried form may further include defoamer. Defoamer may be used to decrease the air content in the blend composition. In some embodiments, the blend composition provided herein in wet or dried form may further include dispersant. The dispersant includes, but is not limited to, polycarboxylate dispersant, with or without polyether unit. The dispersant includes those chemicals that also function as a plasticizer, water reducer such as a high range water reducer, fluidizer, anti-flocculating agent, or superplasticizer for composition, such as lignosulfonate, salt of sulfonated naphthalene sulfonate condensate, salt of sulfonated melamine sulfonate condensate, beta naphthalene sulfonate, sulfonated melamine formaldehyde condensate, naphthalene sulfonate formaldehyde condensate resin for example LOMAR D® dispersant, polyaspartate, or oligomeric dispersant. In some embodiments, the blend composition provided herein in wet or dried form may further include polycarboxylate dispersant having a carbon backbone with pendant side chain, wherein at least a portion of the side chain is attached to the backbone through a carboxyl group or an ether group.

Natural and synthetic admixture may be used to color the product for aesthetic and safety reasons. The coloring admixture may be composed of pigment and include carbon black, iron oxide, phthalocyanine, umber, chromium oxide, titanium oxide, cobalt blue, and organic coloring agent. In some embodiments, the blend composition provided herein in wet or dried form may further include corrosion inhibitor. Corrosion inhibitor may serve to protect embedded reinforcing steel from corrosion. The material commonly used to inhibit corrosion is calcium nitrite, sodium nitrite, sodium benzoate, certain phosphates or fluorosilicate, fluoroaluminite, amine and related chemical. In some embodiments, the blend composition provided herein in wet or dried form may further include damp-proofing admixture. Damp-proofing admixture reduce the permeability of the product that has low cement content, high water-cement ratio, or a deficiency of fines in the aggregate. The admixture may retard moisture penetration into dry product and include certain soap, stearate, and petroleum product. In some embodiments, the blend composition provided herein in wet or dried form may further include gas former admixture. Gas former, or gas-forming agent, may sometimes be added to the mix to cause a slight expansion prior to hardening. The amount of expansion may be dependent upon the amount of gas-forming material used and the temperature of the fresh mixture. Aluminum powder, resin soap and vegetable or animal glue, saponin or hydrolyzed protein can be used as gas former. In some embodiments, the blend composition provided herein in wet or dried form may further include permeability reducer. Permeability reducer may be used to reduce the rate at which water under pressure is transmitted through the mix. Silica fume, fly ash, ground slag, natural pozzolan, water reducer, and latex may be employed to decrease the permeability of the mix.

In some embodiments, the blend composition provided herein in wet or dried form may further include rheology modifying agent admixture. Rheology modifying agent may be used to increase the viscosity of the composition. Suitable examples of rheology modifier include firmed silica, colloidal silica, hydroxyethyl cellulose, starch, hydroxypropyl cellulose, fly ash (as defined in ASTM C618), mineral oil (such as light naphthenic), clay such as hectorite clay, polyoxyalkylene, polysaccharide, natural gum, or mixture thereof. Some of the mineral extender such as, but not limited to, sepiolite clay may be used as the rheology modifying agent.

In some embodiments, the blend composition provided herein in wet or dried form may further include shrinkage compensation admixture. Bacterial and fungal growth on or in hardened product may be partially controlled through the use of fungicidal and germicidal admixture. The material for this purpose includes, but not limited to, polyhalogenated phenol, dialdrin emulsion, and copper compound. Also of interest in some embodiments is workability improving admixture. Entrained air, which acts like a lubricant, can be used as a workability improving agent. Other workability agents are water reducers and certain finely divided admixtures.

In some embodiments, the blend composition provided herein in wet or dried form may further include reinforced material such as fiber, e.g., where fiber-reinforced product is desirable. Fiber can be made of zirconia containing materials, aluminum, glass, steel, carbon, ceramic, grass, bamboo, wood, fiberglass, or synthetic materials, e.g., polypropylene, polycarbonate, polyvinyl chloride, polyvinyl alcohol, nylon, polyethylene, polyester, rayon, high-strength aramid, (i.e., Kevlar), or mixture thereof. The reinforced material is described in U.S. patent application Ser. No. 13/560,246, filed Jul. 27, 2012, which is incorporated herein in its entirety in the present disclosure.

In some embodiments of the blend composition provided herein, the composition has a pH of between 10-14, or between 10-13, or between 10-12, or between 10-11, or between 12-14.

In some embodiments of the foregoing aspects and the foregoing embodiments, the blend composition provided herein after combination with water, setting, and hardening (i.e. transformation of the reactive vaterite to the aragonite and/or the calcite) has a compressive strength of at least 3 MPa; at least 7 MPa; at least 14 MPa; or at least 16 MPa; or at least 18 MPa; or at least 20 MPa; or at least 21 MPa; or at least 25 MPa; or at least 30 MPa; or at least 35 MPa; or at least 40 MPa; or at least 45 MPa; or at least 50 MPa; or at least 55 MPa; or at least 60 MPa; or at least 65 MPa; or at least 70 MPa; or at least 75 MPa; or at least 80 MPa; or at least 85 MPa; or at least 90 MPa; or at least 95 MPa; or at least 100 MPa; or from 3-50 MPa; or from 3-25 MPa; or from 3-15 MPa; or from 3-10 MPa; or from 14-25 MPa; or from 14-100 MPa; or from 14-80 MPa; or from 14-75 MPa; or from 14-50 MPa; or from 14-25 MPa; or from 17-35 MPa; or from 17-25 MPa; or from 20-100 MPa; or from 20-75 MPa; or from 20-50 MPa; or from 20-40 MPa; or from 30-90 MPa; or from 30-75 MPa; or from 30-60 MPa; or from 40-90 MPa; or from 40-75 MPa; or from 50-90 MPa; or from 50-75 MPa; or from 60-90 MPa; or from 60-75 MPa; or from 70-90 MPa; or from 70-80 MPa; or from 70-75 MPa; or from 80-100 MPa; or from 90-100 MPa; or from 90-95 MPa; or 14 MPa; or 3 MPa; or 7 MPa; or 16 MPa; or 18 MPa; or 20 MPa; or 21 MPa; or 25 MPa; or 30 MPa; or 35 MPa; or 40 MPa; or 45 MPa. For example, in some embodiments of the foregoing aspects and the foregoing embodiments, the blend composition after setting, and hardening has a compressive strength of 3 MPa to 25 MPa; or 14 MPa to 40 MPa; or 17 MPa to 40 MPa; or 20 MPa to 40 MPa; or 30 MPa to 40 MPa; or 35 MPa to 40 MPa; or 45 MPa to 60 MPa. In some embodiments, the compressive strength described herein is the compressive strength after 1 day, or 3 days, or 7 days, or 28 days, or 56 days, or longer. In some embodiments, the composition after setting and hardening has a 28-day compressive strength of at least 21 MPa.

In one aspect, there are provided concrete mixes comprising any of the foregoing blend compositions.

### II. Methods and Systems

In one aspect there are provided methods of producing the cement blend composition, comprising (i) producing the reactive vaterite cement composition; and (ii) blending the SCM comprising aluminosilicate material with the reactive vaterite cement composition to produce the cement blend composition. In some embodiments, the cement blend composition may be blended with the Portland cement clinker to form the blend composition or the cement blend composition of the invention. In some embodiments, other SCM materials such as but not limited to, the carbonate material, the alkali metal accelerator, the alkaline earth metal accelerator, the admixture, the additive, the plasticizer and the like, may be blended in the composition to form the blend composition or the cement blend composition of the invention. The “blend composition” and the “cement blend composition” have been used interchangeably herein.

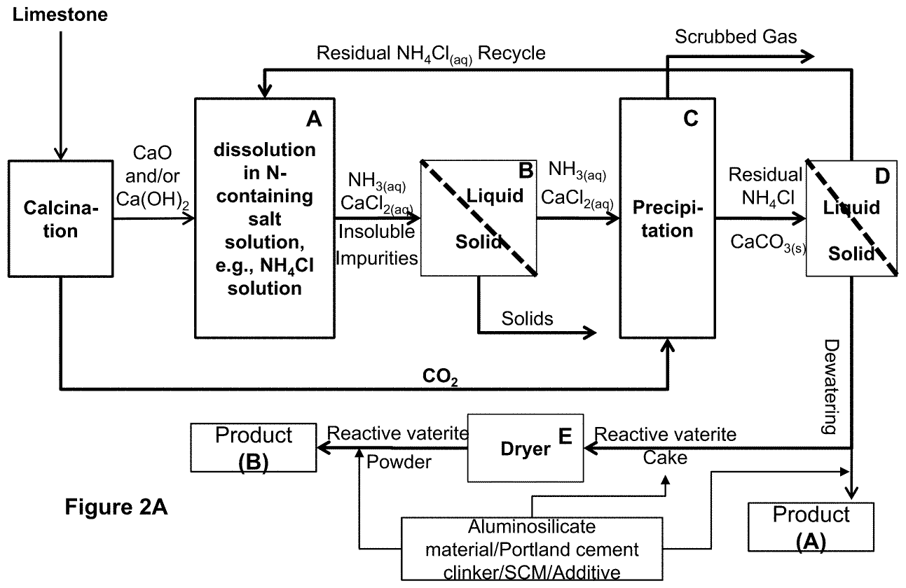

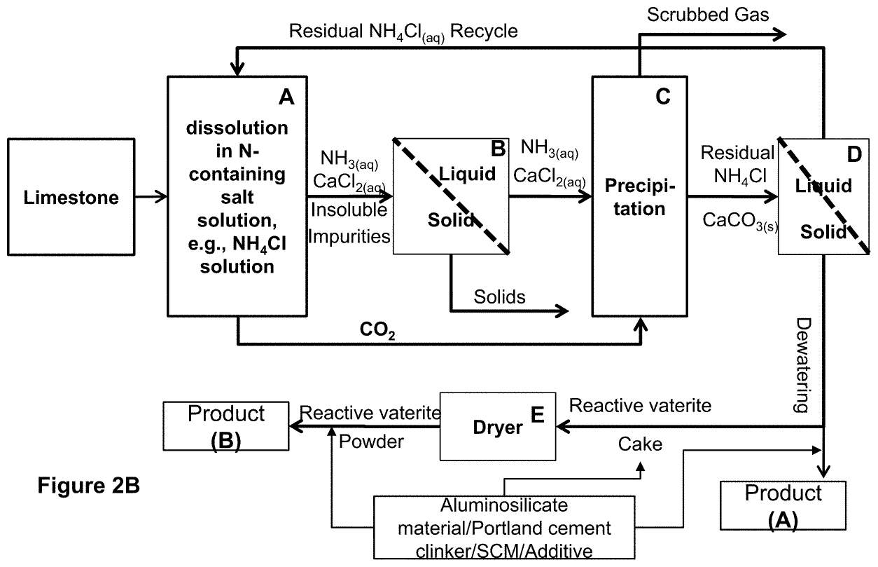

The reactive vaterite cement composition can be prepared using various methods, as described further herein and illustrated in FIGS. 2A, 2B, 3A, 3B, 4A, and 4B. The reactive vaterite cement composition can be produced using limestone as a feedstock where the limestone is used as is in the process or is calcined to form lime. The methods and systems provided herein to produce the reactive vaterite cement composition have several advantages, such as but not limited to, reduction of carbon dioxide emissions through the incorporation of the carbon dioxide back into the process to form the reactive vaterite. Production of the vaterite containing precipitate, in the methods and systems provided herein, offers advantages including, operating expense saving through the reduction in fuel consumption, and reduction in carbon footprint. In the methods and systems provided herein, the emissions of the CO₂ from the calcination of the limestone to the lime may be avoided by recapturing it back in the cementitious reactive vaterite material. By recapturing the carbon dioxide, the cement product has the potential to eliminate significant amount of the cement carbon dioxide emissions and total global emissions from all sources. This reactive vaterite cement composition provided herein can be used to replace Ordinary Portland Cement (OPC) or Portland cement clinker either entirely or partially as SCM.

In some embodiments, the limestone can be used directly to form the reactive vaterite cement composition (as illustrated in FIGS. 2B, 3B, and 4B) or the limestone may be calcined to form lime which may be used to form the reactive vaterite cement composition (as illustrated in FIGS. 2A, 3A, and 4A).

In one aspect, there are provided methods to produce the reactive vaterite cement composition by (a) calcining limestone to form a mixture comprising lime and a gaseous stream comprising carbon dioxide; (b) dissolving the mixture comprising lime in a N-containing salt solution to produce an aqueous solution comprising calcium salt; and (c) treating the aqueous solution comprising calcium salt with the gaseous stream comprising carbon dioxide to form a composition comprising reactive vaterite cement.

In one aspect, there are provided methods to produce the reactive vaterite cement composition by (a) dissolving limestone in a N-containing salt solution to produce an aqueous solution comprising calcium salt, and a gaseous stream comprising carbon dioxide; and (b) treating the aqueous solution comprising calcium salt with the gaseous stream comprising carbon dioxide to form a composition comprising reactive vaterite cement.

The aforementioned aspects and embodiments of the methods and systems provided herein are as illustrated in FIGS. 2A, 2B, 3A, 3B, 4A, and 4B. It is to be understood that the steps illustrated in the figures may be modified or the order of the steps may be changed or more steps may be added or deleted depending on the desired outcome.

The calcination or the calcining is a thermal treatment process to bring about a thermal decomposition of the limestone. The “limestone” as used herein, means CaCO₃ and may further include other impurities typically present in the limestone. Limestone is a naturally occurring mineral. The chemical composition of this mineral may vary from region to region as well as between different deposits in the same region. Therefore, the lime containing the calcium oxide and/or the calcium hydroxide obtained from calcining limestone from each natural deposit may be different. Typically, limestone may be composed of calcium carbonate (CaCO₃), magnesium e.g., magnesium carbonate (MgCO₃), silica (SiO₂), alumina (Al₂O₃), iron (Fe), sulphur (S) or other trace elements.

Limestone deposits are widely distributed. The limestone from the various deposits may differ in physical chemical properties and can be classified according to their chemical composition, texture, and geological formation. Limestone may be classified into the following types: high calcium limestone where the carbonate content may be composed mainly of calcium carbonate with a magnesium carbonate content not more than 5%; magnesium limestone containing magnesium carbonate to about 5-35%; or dolomitic limestone which may contain between 35-46% of MgCO₃, the balance amount is calcium carbonate. Limestones from different sources may differ considerably in chemical compositions and physical structures. It is to be understood that the methods and systems provided herein apply to all the cement plants calcining the limestone from any of the sources listed above or commercially available. The quarries include, but not limited to, quarries associated with cement kilns, quarries for lime rock for aggregate for use in concrete, quarries for lime rock for other purposes (road base), and/or quarries associated with lime kilns.

The limestone calcination is a decomposition process where the chemical reaction for decomposition of the limestone is:

CaCO₃→CaO+CO₂ (g)

This step is illustrated in FIGS. 2A, 3A, and 4A as a first step of the calcination of the limestone to form the lime. However, in some embodiments, the calcination step can be obviated, and the limestone is used directly as a feed stock (FIGS. 2B, 3B, and 4B).

In some embodiments, the limestone comprises between about 1-70% magnesium and/or a magnesium bearing mineral is mixed with the limestone before the calcination wherein the magnesium bearing mineral comprises between about 1-70% magnesium. In some embodiments, the magnesium upon the calcination forms the magnesium oxide which may be precipitated and/or incorporated in the reactive vaterite cement once formed. In some embodiments, the magnesium bearing mineral comprises magnesium carbonate, magnesium salt, magnesium hydroxide, magnesium silicate, magnesium sulfate, or combination thereof. In some embodiments, the magnesium bearing mineral includes, but not limited to, dolomite, magnesite, brucite, carnallite, talc, olivine, artinite, hydromagnesite, dypingite, barringonite, nesquehonite, lansfordite, kieserite, and combination thereof. In some embodiments, the magnesium oxide in the reactive vaterite cement composition when comes in contact with water, transforms to the magnesium hydroxide which may bind with the transformed aragonite and/or calcite. The addition of the magnesium oxide in the reactive vaterite has been described in detail in U.S. Provisional Application No. 63/176,709, filed Apr. 19, 2021, which is incorporated herein by reference in its entirety.

The “lime” as used herein relates to calcium oxide and/or calcium hydroxide. The presence and amount of the calcium oxide and/or the calcium hydroxide in the lime would vary depending on the conditions for the lime formation. The lime may be in dry form i.e., calcium oxide, and/or in wet form e.g., calcium hydroxide, depending on the conditions. The production of the lime may depend upon the type of kiln, conditions of the calcination, and the nature of the raw material i.e., limestone. At relatively low calcination temperatures, products formed in the kiln may contain both un-burnt carbonate and lime and may be called underburnt lime. As the temperature increases, soft burnt or high reactive lime may be produced. At still higher temperatures, dead burnt or low reactive lime may be produced. Soft burnt lime is produced when the reaction front reaches the core of the charged limestone and converts all carbonate present to lime. A high productive product may be relatively soft, contains small lime crystallites and has open porous structure with an easily assessable interior. Such lime may have the optimum properties of high reactivity, high surface area and low bulk density. Increasing the degree of calcination beyond this stage may make lime crystallites to grow larger, agglomerate and sinter. This may result in a decrease in surface area, porosity and reactivity and an increase in bulk density. This product may be known as dead burnt or low reactive lime. Without being limited by any theory, the methods and systems provided herein utilize any one or the combination of the aforementioned lime. Therefore, in some embodiments, the lime is dead burnt, soft burnt, underburnt, or combinations thereof.

Production of the lime by calcining the limestone may be carried out using various types of kilns, such as, but not limited to, a shaft kiln or a rotary kiln or an electric kiln. The use of the electric kiln in the calcination and the advantages associated with it, have been described in U.S. application Ser. No. 17/363,537, filed Jun. 30, 2021, which is fully incorporated herein by reference in its entirety.

These apparatuses for the calcining are suitable for calcining the limestone in the form of lumps having diameters of several to tens millimeters. Cement plant waste streams include waste streams from both wet process and dry process plants, which plants may employ shaft kilns, rotary kilns, electric kilns, or combinations thereof and may include pre-calciners. These industrial plants may each burn a single fuel or may burn two or more fuels sequentially or simultaneously.

As illustrated in FIGS. 2A, 2B, 3A, 3B, 4A, and 4B, the limestone obtained from the limestone quarry is subjected to the calcination in a cement plant resulting in the formation of the lime and CO₂ gas or is used directly. The lime may be calcium oxide in the form of a solid from dry kilns/cement processes and/or may be a combination of calcium oxide and calcium hydroxide in the form of slurry in wet kilns/cement processes. When wet the calcium oxide (also known as a base anhydride that converts to its hydroxide form in water) may be present in its hydrated form such as but not limited to, calcium hydroxide. While calcium hydroxide (also called slaked lime) is a common hydrated form of calcium oxide, other intermediate hydrated and/or water complexes may also be present in the slurry and are all included within the scope of the methods and systems provided herein. It is to be understood that while the lime is illustrated as CaO in some of the figures herein, it may be present as Ca(OH)₂ or combination of CaO and Ca(OH)₂.

The lime or the limestone may be sparingly soluble in water. In the methods and systems provided herein, the lime or the limestone solubility is increased by its treatment with solubilizers.

In the methods and systems provided herein, the lime or the limestone is solvated or dissolved or solubilized with a solubilizer, (step A in FIGS. 2A, 2B, 3A, 3B, 4A, and 4B) to produce the aqueous solution comprising calcium salt. For illustration purposes only, the N-containing salt solution is being illustrated in the figures as ammonium chloride (NH₄Cl) solution and the subsequent calcium salt is being illustrated as calcium chloride (CaCl₂)). Various examples of the N-containing salt have been provided herein and are all within the scope of the invention.

In some embodiments, the N-containing salt solution solubilizes or dissolves the calcium from the lime or the limestone and leaves the solid impurities. The N-containing salt include without limitation, N-containing inorganic salt, N-containing organic salt, or combination thereof.

The “N-containing inorganic salt” as used herein includes any inorganic salt with nitrogen in it. Examples of N-containing inorganic salt include, but not limited to, ammonium halide (halide is any halogen), ammonium sulfate, ammonium sulfite, ammonium nitrate, ammonium nitrite, and the like. In some embodiments, the ammonium halide is ammonium chloride or ammonium bromide. In some embodiments, the ammonium halide is ammonium chloride.

The “N-containing organic salt” as used herein includes any salt of an organic compound with nitrogen in it. Examples of N-containing organic compounds include, but not limited to, aliphatic amine, alicyclic amine, heterocyclic amine, and combination thereof.

The “aliphatic amine” as used herein includes any alkyl amine of formula (R)ₙ—NH₃₋ₙ where n is an integer from 1-3, wherein R is independently between C1-C8 linear or branched and substituted or unsubstituted alkyl. An example of the corresponding halide salt (chloride salt, bromide salt, fluoride salt, or iodide salt) of the alkyl amine of formula (R)ₙ—NH₃₋ₙ is (R)ₙ—NH₄₋ₙ⁺Cl⁻. In some embodiments, when R is substituted alkyl, the substituted alkyl is independently substituted with halogen, hydroxyl, acid and/or ester.

For example, when R is alkyl in (R)ₙ—NH₃₋ₙ, the alkyl amine can be a primary alkyl amine, such as for example only, methylamine, ethylamine, butylamine, pentylamine, etc.; the alkyl amine can be a secondary amine, such as for example only, dimethylamine, diethylamine, methylethylamine, etc.; and/or the alkyl amine can be a tertiary amine, such as for example only, trimethylamine, triethylamine, etc.

For example, when R is substituted alkyl substituted with hydroxyl in (R)ₙ—NH₃₋ₙ, the substituted alkyl amine is an alkanolamine including, but not limited to, monoalkanolamine, dialkanolamine, or trialkanolamine, such as e.g., monoethanolamine, diethanolamine, or triethanolamine, etc.

For example, when R is substituted alkyl substituted with halogen in (R)ₙ—NH₃₋ₙ, the substituted alkyl amine is, for example, chloromethylamine, bromomethylamine, chloroethylamine, bromoethylamine, etc.

For example, when R is substituted alkyl substituted with acid in (R)ₙ—NH₃₋ₙ, the substituted alkyl amine is, for example, amino acid. In some embodiments, the aforementioned amino acid has a polar uncharged alkyl chain, examples include without limitation, serine, threonine, asparagine, glutamine, or combination thereof. In some embodiments, the aforementioned amino acid has a charged alkyl chain, examples include without limitation, arginine, histidine, lysine, aspartic acid, glutamic acid, or combination thereof. In some embodiments, the aforementioned amino acid is glycine, proline, or combination thereof.

The “alicyclic amine” as used herein includes any alicyclic amine of formula (R)ₙ—NH₃₋ₙ where n is an integer from 1-3, wherein R is independently one or more all-carbon rings which may be either saturated or unsaturated, but do not have aromatic character. Alicyclic compounds may have one or more aliphatic side chains attached. An example of the corresponding salt of the alicyclic amine of formula (R)ₙ—NH₃₋ₙ is (R)ₙ—NH₄₋ₙ⁺Cl⁻. Examples of alicyclic amine include, without limitation, cycloalkylamine: cyclopropylamine, cyclobutylamine, cyclopentylamine, cyclohexylamine, cycloheptylamine, cyclooctylamine, and so on.

The “heterocyclic amine” as used herein includes at least one heterocyclic aromatic ring attached to at least one amine. Examples of heterocyclic rings include, without limitation, pyrrole, pyrrolidine, pyridine, pyrimidine, etc. Such chemicals are well known in the art and are commercially available.

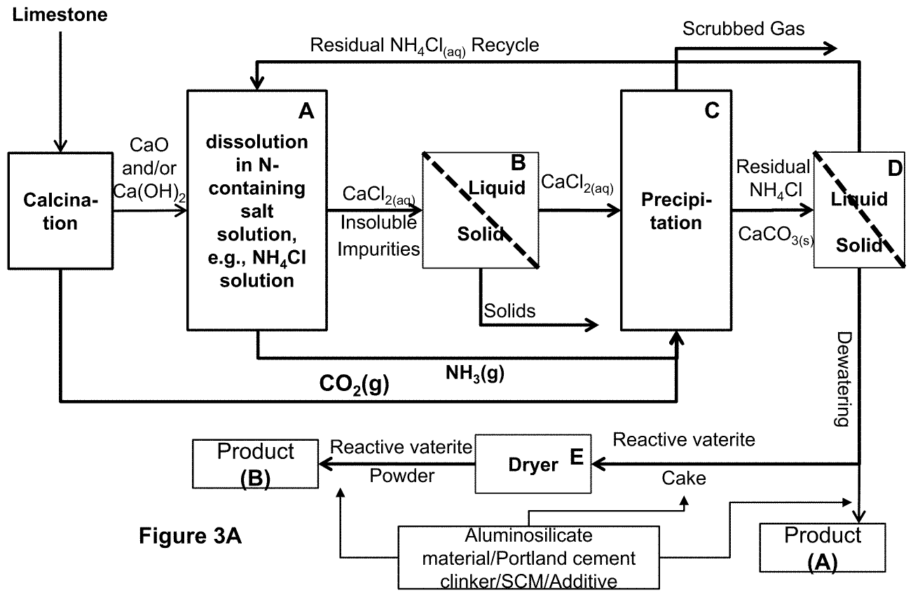

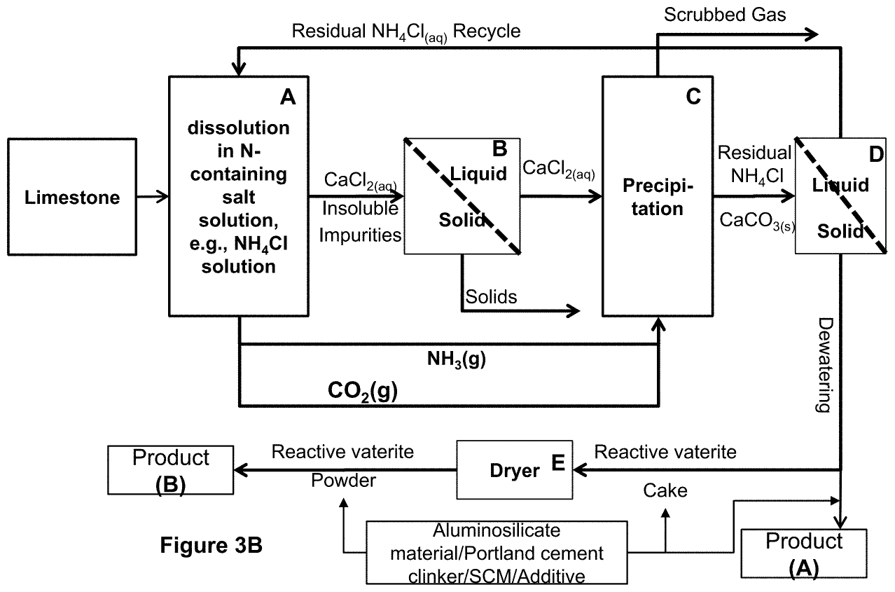

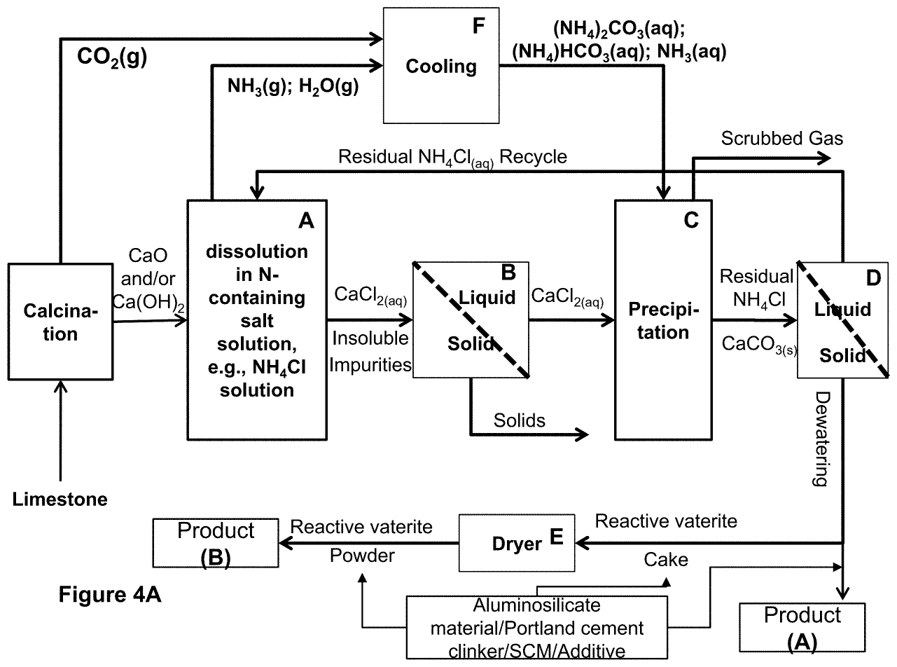

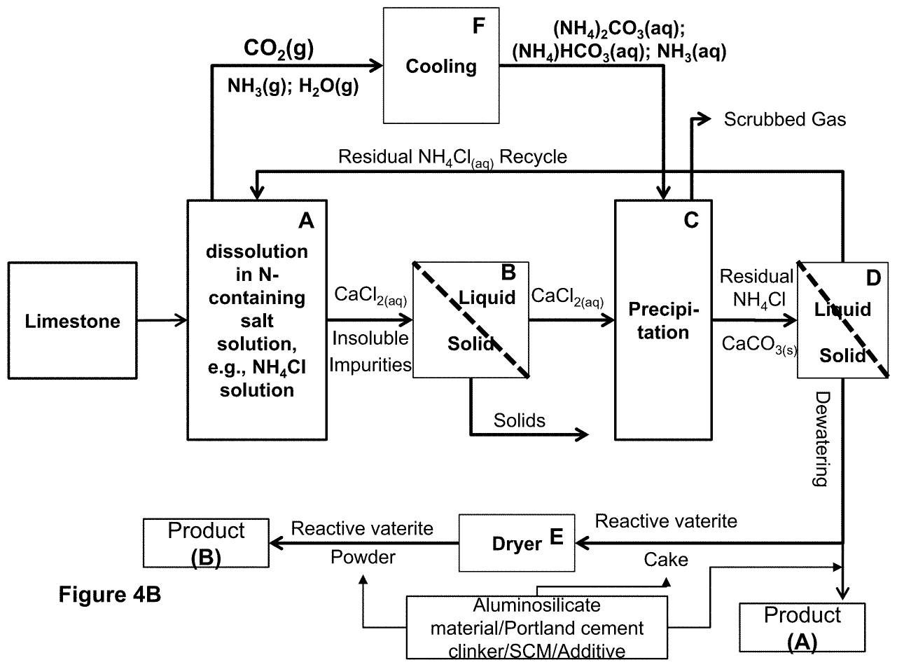

In the methods and systems provided herein, the limestone or the lime is dissolved or solubilized with the N-containing salt solution (step A) to produce the aqueous solution comprising calcium salt. The dissolution step may form ammonia in the aqueous solution (illustrated in FIGS. 2A and 2B) and/or form a gaseous stream comprising ammonia gas (illustrated in FIGS. 3A, 3B, 4A, and 4B).

As illustrated in step A of FIGS. 2A, 3A, and 4A, the N-containing salt is exemplified as ammonium chloride (NH₄Cl). The lime is solubilized by treatment with NH₄Cl (new and recycled as further explained below) when the reaction that may occur is:

CaO+2NH₄Cl (aq)→CaCl₂ (aq)+2NH₃+H₂O

Ca(OH)₂+2NH₄Cl (aq)→2NH₃+CaCl₂+2H₂O

Similarly, when the N-containing salt is N-containing organic salt, the reaction may be shown as below:

CaO+2NH₃RCl→CaCl₂ (aq)+2NH₂R+H₂O

Similarly, illustrated in step A of FIGS. 2B, 3B, and 4B, the N-containing salt is exemplified as ammonium chloride (NH₄Cl). The limestone is solubilized by treatment with NH₄Cl (new and recycled as further explained below) when the reaction that may occur is:

CaCO₃ (limestone)+2NH₄Cl→CaCl₂ (aq)+2NH₃+CO₂+H₂O

Similarly, when the base is N-containing organic salt, the reaction may be shown as below:

CaCO₃ (limestone)+2NH₃RCl→CaCl₂ (aq)+2NH₂R+CO₂+H₂O

In some embodiments, the base or the N-containing inorganic salt such as, but not limited to, an ammonium salt, e.g., ammonium chloride solution may be supplemented with anhydrous ammonia or an aqueous solution of ammonia to maintain an optimum level of ammonium chloride in the solution.

In some embodiments, the aqueous solution comprising calcium salt obtained after dissolution of the lime or the limestone may contain sulfur depending on the source of the limestone. The sulfur may get introduced into the aqueous solution after the solubilization of the lime or the limestone with any of the N-containing salt described herein. In an alkaline solution, various sulfur compounds containing various sulfur ionic species may be present in the solution including, but not limited to, sulfite (SO₃²⁻), sulfate (SO₄²⁻), hydrosulfide (HS⁻), thiosulfate (S₂O₃²⁻), polysulfides (Sₙ²⁻), thiol (RSH), and the like. The “sulfur compound” as used herein, includes any sulfur ion containing compound.

In some embodiments, the aqueous solution further comprises the N-containing salt, such as, ammonia and/or N-containing inorganic or N-containing organic salt.

In some embodiments, the amount of the N-containing inorganic salt, the N-containing organic salt, or combination thereof, is in more than 20% excess or more than 30% excess to the lime or the limestone. In some embodiments, the molar ratio of the N-containing salt:lime (or N-containing inorganic salt:lime or N-containing organic salt:lime or ammonium chloride:lime) or the molar ratio of the N-containing salt:limestone (or N-containing inorganic salt:limestone or N-containing organic salt:limestone or ammonium chloride:limestone) is between 0.5:1-2:1; or 0.5:1-1.5:1; or 1:1-1.5:1; or 1.5:1; or 2:1; or 2.5:1; or 1:1.

In some embodiments of the methods and systems described herein, the dissolution step is under one or more dissolution conditions selected from the group consisting of temperature between about 30-200° C., or between about 30-150° C., or between about 30-100° C., or between about 30-75° C., or between about 30-50° C., or between about 40-200° C., or between about 40-150° C., or between about 40-100° C., or between about 40-75° C., or between about 40-50° C., or between about 50-200° C., or between about 50-150° C., or between about 50-100° C.; pressure between about 0.1-50 atm, or between about 0.1-40 atm, or between about 0.1-30 atm, or between about 0.1-20 atm, or between about 0.1-10 atm, or between about 0.5-20 atm; N-containing inorganic or organic salt wt % in water between about 0.5-50%, or between about 0.5-25%, or between about 0.5-10%, or between about 3-30%, or between about 5-20%; or combinations thereof.

Agitation may be used to affect dissolution of the lime or the limestone with the N-containing salt solution in the dissolution reactor, for example, by eliminating hot and cold spots. In some embodiments, the concentration of the lime or the limestone in water may be between 1 and 10 g/L, 10 and 20 g/L, 20 and 30 g/L, 30 and 40 g/L, 40 and 80 g/L, 80 and 160 g/L, 160 and 320 g/L, 320 and 640 g/L, or 640 and 1280 g/L. To optimize the dissolution/solvation of the lime or the limestone, high shear mixing, wet milling, and/or sonication may be used to break open the lime or the limestone. During or after high shear mixing and/or wet milling, the lime or the limestone suspension may be treated with the N-containing salt solution.

In some embodiments, the dissolution of the lime or the limestone with the N-containing salt solution (illustrated as e.g., ammonium chloride) results in the formation of the aqueous solution comprising calcium salt and solid. In some embodiments, the solid insoluble impurities may be removed from the aqueous solution of the calcium salt (step B in FIGS. 2A, 2B, 3A, 3B, 4A, and 4B) before the aqueous solution is treated with the carbon dioxide in the process. The solid may optionally be removed from the aqueous solution by filtration and/or centrifugation techniques.

It is to be understood that the step B in FIGS. 2A, 2B, 3A, 3B, 4A, and 4B is optional and in some embodiments, the solid may not be removed from the aqueous solution (not shown in the figures) and the aqueous solution containing calcium salt as well as the solid is contacted with the carbon dioxide (in step C in FIGS. 2A, 2B, 3A, 3B, 4A, and 4B) to form the precipitate. In such embodiments, the precipitation material further comprises solid.

In some embodiments, the solid obtained from the dissolution of the lime or the limestone (shown as insoluble impurities in FIGS. 2A, 2B, 3A, 3B, 4A, and 4B) is calcium depleted solid and may be used as a cement substitute (such as a substitute for Portland cement). In some embodiments, the solid comprises silicate, iron oxide, alumina, or combination thereof. The silicate includes, without limitation, clay (phyllosilicate), alumino-silicate, etc.

In some embodiments, the solid is between about 1-85 wt %; or between about 1-80 wt %; or between about 1-75 wt %; or between about 1-70 wt %; or between about 1-60 wt %; or between about 1-50 wt %; or between about 1-40 wt %; or between about 1-30 wt %; or between about 1-20 wt %; or between about 1-10 wt % or between about 1-5 wt %; or between about 1-2 wt %, in the aqueous solution, in the precipitation material, in the composition, in the blend composition, or combination thereof.

As illustrated in step C in FIGS. 2A, 2B, 3A, 3B, 4A, and 4B, the aqueous solution comprising calcium salt (and optionally solid) and dissolved ammonia and/or ammonium salt is contacted with the gaseous stream comprising carbon dioxide recycled from the calcination step of the limestone calcination process or the dissolution step of the direct limestone process, to form the precipitation material comprising calcium carbonate and a supernatant solution, wherein the calcium carbonate comprises reactive vaterite, shown in the reaction below:

CaCl₂ (aq)+2NH₃ (aq)+CO₂ (g)+H₂O→CaCO₃ (s)+2NH₄Cl (aq)

The absorption of the CO₂ into the aqueous solution produces CO₂-charged water containing carbonic acid, a species in equilibrium with both bicarbonate and carbonate. The precipitation material may be prepared under one or more precipitation conditions (as described herein) suitable to form the reactive vaterite cement material.

In one aspect, the ammonia formed in the dissolution step A may be partially or fully present in a gaseous form. This aspect is illustrated in FIGS. 3A and 3B.

In one aspect, there are provided methods to form the reactive vaterite cement composition by (a) calcining the limestone to form the mixture comprising lime and the gaseous stream comprising carbon dioxide; (b) dissolving the mixture comprising lime in the N-containing salt solution to produce the aqueous solution comprising calcium salt, and the gaseous stream comprising ammonia; and (c) treating the aqueous solution comprising calcium salt with the gaseous stream comprising carbon dioxide and the gaseous stream comprising ammonia to form the composition comprising reactive vaterite cement. This aspect is illustrated in FIG. 3A, wherein the gaseous stream comprising CO₂ from the calcination step and the gaseous stream comprising NH₃ from step A of the process is recirculated to the precipitation reactor (step C) for the formation of the reactive vaterite cement. Remaining steps of FIG. 3A are identical to the steps of FIG. 2A. It is to be understood that the processes of both FIG. 2A and FIG. 3A can also take place simultaneously such that the N-containing salt, such as the N-containing inorganic salt or the N-containing organic salt and optionally ammonia may be partially present in the aqueous solution and partially present in the gaseous stream.

The reaction taking place in the aforementioned aspect may be shown as below:

CaCl₂ (aq)+2NH₃ (g)+CO₂ (g)+H₂O→CaCO₃ (s)+2NH₄Cl (aq)

In one aspect, there are provided methods to form the reactive vaterite cement composition by (a) dissolving the limestone in the N-containing salt solution to produce the aqueous solution comprising calcium salt, and the gaseous stream comprising ammonia and the gaseous stream comprising carbon dioxide; and (c) treating the aqueous solution comprising calcium salt with the gaseous stream comprising carbon dioxide and the gaseous stream comprising ammonia to form the composition comprising reactive vaterite cement. This aspect is illustrated in FIG. 3B, wherein the gaseous stream comprising CO₂ and the gaseous stream comprising NH₃ from step A of the process is recirculated to the precipitation reactor (step C) for the formation of the reactive vaterite cement. Remaining steps of FIG. 3B are identical to the steps of FIG. 2B. It is to be understood that the processes of both FIG. 2B and FIG. 3B can also take place simultaneously such that the N-containing salt, such as the N-containing inorganic salt or the N-containing organic salt and optionally ammonia may be partially present in the aqueous solution and partially present in the gaseous stream.

In some embodiments of the aspects and embodiments provided herein, the gaseous stream comprising ammonia may have ammonia from an external source and/or is recovered and recirculated from step A of the process.

In some embodiments of the aspects and embodiments provided herein, wherein the gaseous stream comprises ammonia and/or the gaseous stream comprises carbon dioxide, no external source of carbon dioxide and/or ammonia is used, and the process is a closed loop process. Such closed loop process is being illustrated in the figures described herein.

In some embodiments, the dissolution of the lime or the limestone with some of the N-containing organic salt may not result in the formation of ammonia gas or the amount of ammonia gas formed may not be substantial. In embodiments where the ammonia gas is not formed or is not formed in substantial amounts, the methods and systems illustrated in FIGS. 2A and 2B where the aqueous solution comprising calcium salt is treated with the carbon dioxide gas, are applicable. In such embodiments, the organic amine salt may remain in the aqueous solution in fully or partially dissolved state or may separate as an organic amine layer, as shown in the reaction below:

CaO+2NH₃R⁺Cl⁻→CaCl₂ (aq)+2NH₂R+H₂O

The N-containing organic salt or the N-containing organic compound remaining in the supernatant solution after the precipitation may be called residual N-containing organic salt or residual N-containing organic compound. Methods and systems have been described herein to recover the residual compounds from the precipitate as well as the supernatant solution.

In one aspect, the ammonia gas and the CO₂ gas may be recovered and cooled down in a cooling reactor before mixing the cooled solution with the aqueous solution comprising calcium salt. This aspect is illustrated in FIGS. 4A and 4B.

In one aspect, there are provided methods to form the reactive vaterite cement composition by (i) calcining the limestone to form the lime and the gaseous stream comprising carbon dioxide; (ii) dissolving the lime in the aqueous N-containing inorganic salt solution or N-containing organic salt solution to produce the first aqueous solution comprising calcium salt, and the gaseous stream comprising ammonia; (iii) recovering the gaseous stream comprising carbon dioxide and the gaseous stream comprising ammonia and subjecting the gaseous streams to a cooling process to condense a second aqueous solution comprising ammonium bicarbonate, ammonium carbonate, ammonia, or combinations thereof; and (iv) treating the first aqueous solution comprising calcium salt with the second aqueous solution comprising ammonium bicarbonate, ammonium carbonate, ammonia, ammonium carbamate, or combination thereof to form the reactive vaterite cement. This aspect is illustrated in FIG. 4A, wherein the gaseous stream comprising CO₂ from the calcination step and the gaseous stream comprising NH₃ from step A of the process is recirculated to the cooling reactor/reaction (step F) for the formation of the carbonate and bicarbonate solutions as shown in the reactions further herein below. Remaining steps of FIG. 4A are identical to the steps of FIGS. 2A and 3A.

It is to be understood that the aforementioned aspect illustrated in FIG. 4A may be combined with the aspects illustrated in FIG. 2A and/or FIG. 3A such that the precipitation step C comprises treating the first aqueous solution comprising calcium salt with the second aqueous solution comprising ammonium bicarbonate, ammonium carbonate, ammonia, ammonium carbamate, or combination thereof (illustrated in FIG. 4A), as well as comprises treating the aqueous solution comprising calcium salt with the gaseous stream comprising carbon dioxide (illustrated in FIG. 2A) and/or comprises treating the aqueous solution comprising calcium salt with the gaseous stream comprising carbon dioxide and the gaseous stream comprising ammonia (illustrated in FIG. 3A). In such embodiments, the gaseous stream comprising carbon dioxide is split between the stream going to the cooling process and the stream going to the precipitation process. Similarly, in such embodiments, the gaseous stream comprising ammonia is split between the stream going to the cooling process and the stream going to the precipitation process. Any combination of the processes depicted in FIGS. 2A, 3A, and 4A is possible and all are within the scope of this disclosure.

In one aspect, there are provided methods to form the reactive vaterite cement composition by (i) dissolving the limestone in the aqueous N-containing inorganic salt solution or N-containing organic salt solution to produce the first aqueous solution comprising calcium salt, the gaseous stream comprising carbon dioxide and the gaseous stream comprising ammonia; (iii) recovering the gaseous stream comprising carbon dioxide and the gaseous stream comprising ammonia and subjecting the gaseous streams to a cooling process to condense a second aqueous solution comprising ammonium bicarbonate, ammonium carbonate, ammonia, ammonium carbamate, or combination thereof; and (iv) treating the first aqueous solution comprising calcium salt with the second aqueous solution comprising ammonium bicarbonate, ammonium carbonate, ammonia, or combination thereof to form the reactive vaterite cement. This aspect is illustrated in FIG. 4B, wherein the gaseous stream comprising CO₂ and the gaseous stream comprising NH₃ from step A of the process are recirculated to the cooling reactor/reaction (step F) for the formation of the carbonate and bicarbonate solutions as shown in the reactions further herein below. Remaining steps of FIG. 4B are identical to the steps of FIGS. 2B and 3B.

It is to be understood that the aforementioned aspect illustrated in FIG. 4B may be combined with the aspects illustrated in FIG. 2B and/or FIG. 3B such that the precipitation step C comprises treating the first aqueous solution comprising calcium salt with the second aqueous solution comprising ammonium bicarbonate, ammonium carbonate, ammonia, ammonium carbamate, or combination thereof (illustrated in FIG. 4B), as well as comprises treating the aqueous solution comprising calcium salt with the gaseous stream comprising carbon dioxide (illustrated in FIG. 2B) and/or comprises treating the aqueous solution comprising calcium salt with the gaseous stream comprising carbon dioxide and the gaseous stream comprising ammonia (illustrated in FIG. 3B). In such embodiments, the gaseous stream comprising carbon dioxide is split between the stream going to the cooling process and the stream going to the precipitation process. Similarly, in such embodiments, the gaseous stream comprising ammonia is split between the stream going to the cooling process and the stream going to the precipitation process. Any combination of the processes depicted in FIGS. 2B, 3B, and 4B is possible and all are within the scope of this disclosure.

In some embodiments of the aforementioned aspects, the second aqueous solution comprises ammonium carbamate. Ammonium carbamate has a formula NH₄[H₂NCO₂] consisting of ammonium ions NH₄⁺, and carbamate ions H₂NCO₂⁻.

The combination of these condensed products in the second aqueous solution may be dependent on the one or more of the cooling conditions. Table 2 presented below represents various combinations of the condensed products in the second aqueous solution.

TABLE 2

| Ammonium | Ammonium | | Ammonium |
|---|---|---|---|
| carbonate | bicarbonate | Ammonia | carbamate |
| X | | | |
| | X | | |
| | | X | |
| | | | X |
| X | X | | |
| X | | X | |
| X | | | X |
| | X | X | |
| | X | | X |
| | | X | X |
| X | X | X | |
| X | X | | X |
| X | X | X | X |
| | X | X | X |

In some embodiments of the aforementioned aspect and embodiments, the gaseous stream (e.g., the gaseous streams going to the cooling reaction/reactor (step F in FIGS. 4A and 4B)) further comprises water vapor. In some embodiments of the aforementioned aspect and embodiments, the gaseous stream further comprises between about 20-90%; or between about 20-80%; or between about 20-70%; or between about 20-60%; or between about 20-55%; or between about 20-50%; or between about 20-40%; or between about 20-30%; or between about 20-25%; or between about 30-90%; or between about 30-80%; or between about 30-70%; or between about 30-60%; or between about 30-50%; or between about 30-40%; or between about 40-90%; or between about 40-80%; or between about 40-70%; or between about 40-60%; or between about 40-50%; or between about 50-90%; or between about 50-80%; or between about 50-70%; or between about 50-60%; or between about 60-90%; or between about 60-80%; or between about 60-70%; or between about 70-90%; or between about 70-80%; or between about 80-90%, water vapor.

Intermediate steps in the cooling reaction/reactor may include the formation of ammonium carbonate and/or ammonium bicarbonate and/or ammonium carbamate, by reactions as below:

2NH₃+CO₂+H₂O→(NH₄)₂CO₃

NH₃+CO₂+H₂O→(NH₄)HCO₃

2NH₃+CO₂→(NH₄)NH₂CO₂

Similar reactions may be shown for the N-containing organic salt:

2NH₂R+CO₂+H₂O→(NH₃R)₂CO₃

NH₂R+CO₂+H₂O→(NH₃R)HCO₃

An advantage of cooling the ammonia in the cooling reaction/reactor is that ammonia may have a limited vapor pressure in the vapor phase of the dissolution reaction. By reacting the ammonia with CO₂, as shown in the reactions above, can remove some ammonia from the vapor space, allowing more ammonia to leave the dissolution solution.

The second aqueous solution comprising ammonium bicarbonate, ammonium carbonate, ammonia, ammonium carbamate, or combination thereof (exiting the cooling reaction/reactor in FIGS. 4A and 4B) is then treated with the first aqueous solution comprising calcium salt from the dissolution reaction/reactor, in the precipitation reaction/reactor (step C) to form the precipitation material comprising reactive vaterite cement:

(NH₄)₂CO₃+CaCl₂→CaCO₃ (vaterite)+2NH₄Cl

(NH₄)HCO₃+NH₃+CaCl₂→CaCO₃ (vaterite)+2NH₄Cl+H₂O

2(NH₄)HCO₃+CaCl₂→CaCO₃ (vaterite)+2NH₄Cl+H₂O+CO₂

(NH₄)NH₂CO₂+H₂O+CaCl₂→CaCO₃ (vaterite)+2NH₄Cl

In some embodiments of the aspects and embodiments provided herein, the cooling step is under one or more cooling conditions comprising temperature between about 0-200° C., or between about 0-150° C., or between about 0-75° C., or between about 0-100° C., or between about 0-80° C., or between about 0-60° C., or between about 0-50° C., or between about 0-40° C., or between about 0-30° C., or between about 0-20° C., or between about 0-10° C.

In some embodiments of the aspects and embodiments provided herein, the one or more cooling conditions comprise pressure between about 0.5-50 atm; or between about 0.5-25 atm; or between about 0.5-10 atm; or between about 0.1-10 atm; or between about 0.5-1.5 atm; or between about 0.3-3 atm.

In some embodiments, the formation and the quality of the reactive vaterite formed in the methods and systems provided herein, is dependent on the amount and/or the ratio of the condensed products in the second aqueous solution comprising ammonium bicarbonate, ammonium carbonate, ammonia, ammonium carbamate, or combination thereof.

In some embodiments, the presence or absence or distribution of the condensed products in the second aqueous solution comprising ammonium bicarbonate, ammonium carbonate, ammonia, ammonium carbamate, or combination thereof, can be optimized in order to maximize the formation of the reactive vaterite and/or to obtain a desired particle size distribution. This optimization can be based on the one or more cooling conditions, such as, pH of the aqueous solution in the cooling reactor, flow rate of the CO₂ and the NH₃ gases, and/or ratio of the CO₂:NH₃ gases. The inlets for the cooling reactor may be carbon dioxide (CO_{2(g)}), the dissolution reactor gas exhaust containing ammonia (NH_{3(g)}), water vapor, and optionally fresh makeup water (or some other dilute water stream). The outlet may be a slipstream of the reactor's recirculating fluid (the second aqueous solution), which is directed to the precipitation reactor for contacting with the first aqueous solution and optionally additional carbon dioxide and/or ammonia. The pH of the system may be controlled by regulating the flow rate of CO₂ and NH₃ into the cooling reactor. The conductivity of the system may be controlled by addition of dilute makeup water to the cooling reactor. Volume may be maintained constant by using a level detector in the cooling reactor or it's reservoir.

It is to be understood that while FIGS. 4A and 4B illustrate a separate cooling reaction/reactor, in some embodiments, the dissolution reaction/reactor may be integrated with the cooling reaction/reactor. For example, the dissolution reactor may be integrated with a condenser acting as a cooling reactor. Various configurations of the integrated reactor described above, are described in U.S. application Ser. No. 17/184,933, filed Feb. 25, 2021, which is incorporated herein by reference in its entirety.

In the aforementioned aspects, both the dissolution and the cooling reactors are fitted with inlets and outlets to receive the required gases and collect the aqueous streams. In some embodiments of the aforementioned aspect, the dissolution reactor comprises a stirrer to mix the lime or the limestone with the aqueous N-containing salt solution. The stirrer can also facilitate upward movement of the gases. In some embodiments of the aforementioned aspect, the dissolution reactor is configured to collect the solids settled at the bottom of the reactor after removing the first aqueous solution comprising calcium salt. In some embodiments of the aforementioned aspect, the cooling tower comprises one or more trays configured to catch and collect the condensed second aqueous solution and prevent it from falling back into the dissolution reactor. As such, the cooling/condensation may be accomplished through use of infusers, bubblers, fluidic Venturi reactors, spargers, gas filters, sprays, trays, or packed column reactors, and the like.

In some embodiments, the contacting of the aqueous solution comprising calcium salt with carbon dioxide and optionally ammonia or second aqueous solution is achieved by contacting the aqueous solution to achieve and maintain a desired pH range, a desired temperature range, and/or desired divalent cation concentration using a convenient protocol as described herein (precipitation conditions). In some embodiments, the systems include a precipitation reactor configured to contact the aqueous solution comprising calcium salt with carbon dioxide and optionally ammonia from step A of the process or the systems include a precipitation reactor configured to contact the first aqueous solution comprising calcium salt with the second aqueous solution comprising ammonium bicarbonate, ammonium carbonate, ammonia, ammonium carbamate, or combination thereof.

In some embodiments, the aqueous solution comprising calcium salt may be placed in a precipitation reactor, wherein the amount of the aqueous solution comprising calcium salt added is sufficient to raise the pH to a desired level (e.g., a pH that induces precipitation of the precipitation material) such as pH 7-9, pH 7-8.7, pH 7-8.5, pH 7-8, pH 7.5-8, pH 8-8.5, pH 8.5-9, pH 9-14, pH 10-14, pH 11-14, pH 12-14, or pH 13-14. In some embodiments, the pH of the aqueous solution comprising calcium salt when contacted with the carbon dioxide and optionally the NH₃ or the second aqueous solution, is maintained at between 7-9 or between 7-8.7 or between 7-8.5 or between 7.5-8.5 or between 7-8, or between 7.6-8.5, or between 8-8.5, or between 7.5-9.5 in order to form the reactive vaterite.

The aqueous solution comprising calcium salt may be contacted with the gaseous stream comprising the CO₂ and optionally the NH₃ using any convenient protocol. The contact protocols of interest include, but not limited to, direct contacting protocols (e.g., bubbling the gases through the first aqueous solution), concurrent contacting means (i.e., contact between unidirectional flowing gaseous and liquid phase streams), countercurrent means (i.e., contact between oppositely flowing gaseous and liquid phase streams), and the like. As such, contact may be accomplished through use of infusers, bubblers, fluidic Venturi reactors, spargers, gas filters, sprays, trays, or packed column reactors, and the like, in the precipitation reactor. In some embodiments, gas-liquid contact is accomplished by forming a liquid sheet of solution with a flat jet nozzle, wherein the gases and the liquid sheet move in countercurrent, co-current, or crosscurrent directions, or in any other suitable manner. In some embodiments, gas-liquid contact is accomplished by contacting liquid droplets of the solution having an average diameter of 500 micrometers or less, such as 100 micrometers or less, with the gas source.

Any number of the gas-liquid contacting protocols described herein may be utilized. Gas-liquid contact or the liquid-liquid contact is continued until the pH of the precipitation reaction mixture is optimum (various optimum pH values have been described herein to form the precipitation material comprising e.g., reactive vaterite), after which the precipitation reaction mixture is allowed to stir. The rate at which the pH drops may be controlled by addition of more of the aqueous solution comprising calcium salt during gas-liquid contact or the liquid-liquid contact. In addition, additional aqueous solution may be added after sparging to raise the pH back to basic levels for precipitation of a portion or all the precipitation material. In any case, the precipitation material may be formed upon removing protons from certain species in the precipitation reaction mixture. The precipitation material comprising carbonates may then be separated and optionally, further processed.

In some embodiments, the precipitation step is under one or more of the precipitation conditions. The one or more precipitation conditions include those that modulate the environment of the precipitation reaction mixture to produce the desired precipitation material comprising reactive vaterite. Such one or more precipitation conditions include, but not limited to, temperature, pH, pressure, ion ratio, precipitation rate, presence of additive, presence of ionic species, concentration of additive and ionic species, stirring, residence time, mixing rate, forms of agitation such as ultrasonics, presence of seed crystal, catalyst, membrane, or substrate, dewatering, drying, ball milling, etc. In some embodiments, the average particle size of the reactive vaterite may also depend on the one or more precipitation conditions used in the precipitation of the precipitation material.

For example, the temperature of the precipitation reaction may be raised to a point at which an amount suitable for precipitation of the desired precipitation material occurs. In such embodiments, the temperature of the precipitation reaction may be raised to a value, such as from 20° C. to 60° C., and including from 25° C. to 60° C.; or from 30° C. to 60° C.; or from 35° C. to 60° C.; or from 40° C. to 60° C.; or from 50° C. to 60° C.; or from 25° C. to 50° C.; or from 30° C. to 50° C.; or from 35° C. to 50° C.; or from 40° C. to 50° C.; or from 25° C. to 40° C.; or from 30° C. to 40° C.; or from 25° C. to 30° C. In some embodiments, the temperature of the precipitation reaction may be raised using energy generated from low or zero carbon dioxide emission sources (e.g., solar energy source, wind energy source, hydroelectric energy source, waste heat from the flue gases of the carbon emitter, etc.).

The pH of the precipitation reaction may also be raised to an amount suitable for the precipitation of the desired precipitation material. In such embodiments, the pH of the precipitation reaction may be raised to alkaline levels for precipitation. In some embodiments, the precipitation conditions required to form the precipitation material include pH higher than 7 or pH of 8 or pH of between 7.1-8.5 or pH of between 7.5-8 or between 7.5-8.5 or between 8-8.5 or between 8-9 or between 7.6-8.4, in order to form the precipitation material. The pH may be raised to pH 9 or higher, such as pH 10 or higher, including pH 11 or higher or pH 12.5 or higher.

Adjusting major ion ratios during precipitation may influence the nature of the precipitation material. Major ion ratios may have considerable influence on polymorph formation. For example, as the magnesium:calcium ratio in the water increases, aragonite may become the major polymorph of calcium carbonate in the precipitation material over low-magnesium vaterite. At low magnesium:calcium ratios, low-magnesium calcite may become the major polymorph. In some embodiments, where Ca²⁺ and Mg²⁺ are both present, the ratio of Ca²⁺ to Mg²⁺ (i.e., Ca²⁺:Mg²⁺) in the precipitation material is 1:1 to 1:2.5; 1:2.5 to 1:5; 1:5 to 1:10; 1:10 to 1:25; 1:25 to 1:50; 1:50 to 1:100; 1:100 to 1:150; 1:150 to 1:200; 1:200 to 1:250; 1:250 to 1:500; or 1:500 to 1:1000. In some embodiments, the ratio of Mg²⁺ to Ca²⁺ (i.e., Mg²⁺:Ca²⁺) in the precipitation material is 1:1 to 1:2.5; 1:2.5 to 1:5; 1:5 to 1:10; 1:10 to 1:25; 1:25 to 1:50; 1:50 to 1:100; 1:100 to 1:150; 1:150 to 1:200; 1:200 to 1:250; 1:250 to 1:500; or 1:500 to 1:1000.

In some embodiments, the one or more precipitation conditions to produce the desired precipitation material from the precipitation reaction may include, as above, the temperature and pH, as well as, in some instances, the concentrations of additive and ionic species in the water. The additive has been described herein below. The presence of the additive and the concentration of the additive may also favor formation of stable or reactive vaterite or PCC. In some embodiments, a middle chain or long chain fatty acid ester may be added to the aqueous solution or the first aqueous solution during the precipitation to form the PCC. Examples of fatty acid ester include, without limitation, cellulose such as carboxymethyl cellulose, sorbitol, citrate such as sodium or potassium citrate, stearate such as sodium or potassium stearate, phosphate such as sodium or potassium phosphate, sodium tripolyphosphate, hexametaphosphate, EDTA, or combinations thereof. In some embodiments, a combination of stearate and citrate may be added during the precipitation step of the process to form the PCC.

In some embodiments, the gas leaving the precipitation reactor (shown as “scrubbed gas” in the figures) passes to a gas treatment unit for a scrubbing process. The mass balance and equipment design for the gas treatment unit may depend on the properties of the gases. In some embodiments, the gas treatment unit may incorporate an HCl scrubber for recovering the small amounts of NH₃ in the gas exhaust stream that may be carried from the CO₂ absorption, precipitation step by the gas. NH₃ may be captured by the HCl solution through:

NH₃ (g)+HCl (aq)→NH₄Cl (aq)

The NH₄Cl (aq) from the HCl scrubber may be recycled to the dissolution step A.

In some embodiments, the gas exhaust stream comprising ammonia (shown as “scrubbed gas” in the figures) may be subjected to a scrubbing process where the gas exhaust stream comprising ammonia is scrubbed with the carbon dioxide from the industrial process and water to produce a solution of ammonia. The inlets for the scrubber may be carbon dioxide (CO_{2(g)}), the reactor gas exhaust containing ammonia (NH_{3(g)}), and fresh makeup water (or some other dilute water stream). The outlet may be a slipstream of the scrubber's recirculating fluid (e.g. H₃N—CO_{2(aq)} or carbamate), which may optionally be returned back to the main reactor for contacting with carbon dioxide and precipitation. The pH of the system may be controlled by regulating the flow rate of CO_{2(g)} into the scrubber.

In some embodiments, the methods and systems provided herein further include separating the precipitation material (step D in FIGS. 2A, 2B, 3A, 3B, 4A, and 4B) from the aqueous solution by dewatering to form reactive vaterite cake or wet form or slurry form of the reactive vaterite cement. The reactive vaterite cement cake may be subjected optionally to rinsing, and optionally drying (step E in FIGS. 2A, 2B, 3A, 3B, 4A, and 4B). The dried reactive vaterite cement cake may then be used to make cementitious product (shown as product (B) in FIGS. 2A, 2B, 3A, 3B, 4A, and 4B). In some embodiments, the reactive vaterite cement cake may not be dried and may be used as is to form cementitious product (shown as product (A) in FIGS. 2A, 2B, 3A, 3B, 4A, and 4B).

The methods and systems provided herein may result in residual N-containing salt such as the residual N-containing inorganic or N-containing organic salt, e.g., residual ammonium salt remaining in the supernatant solution as well as in the precipitate itself after the formation of the precipitate. The residual base such as the N-containing inorganic or N-containing organic salt, e.g., residual ammonium salt (e.g., residual NH₄Cl) as used herein includes any salt that may be formed by ammonium ions and anions present in the solution including, but not limited to halogen ion such as chloride ion, nitrate or nitrite ion, and sulfur ion such as, sulfate ion, sulfite ion, thiosulfate ion, hydrosulfide ion, and the like. In some embodiments, the residual N-containing inorganic salt comprises ammonium halide, ammonium sulfate, ammonium sulfite, ammonium hydrosulfide, ammonium thiosulfate, ammonium nitrate, ammonium nitrite, or combination thereof. These residual salts may be removed and optionally recovered from the supernatant solution as well as the precipitate. In some embodiments, the supernatant solution further comprising the N-containing inorganic or N-containing organic salt, e.g., residual ammonium salt (e.g., residual NH₄Cl), is recycled back to the dissolution reactor for the dissolution of the lime or the limestone (to step A in FIGS. 2A, 2B, 3A, 3B, 4A, and 4B).

The cake comprising reactive vaterite cement may be sent to the dryer (step E in FIGS. 2A, 2B, 3A, 3B, 4A, and 4B) to form dry powder composition containing reactive vaterite cement. The powder form of the reactive vaterite cement may be used further in applications to form products, as described herein. The cake may be dried using any drying techniques known in the art such as, but not limited to fluid bed dryer or swirl fluidizer. The resulting solid powder may be then mixed with aluminosilicate material, SCM, e.g., limestone, Portland cement clinker, admixtures, accelerators, additives, or mixture thereof to make different the blend composition described herein. In some embodiments, the slurry form with reduced water or the cake form of the reactive vaterite cement is directly used to form product, as described herein.

In some embodiments, the resultant dewatered cake obtained from the separation station is dried at the drying station to produce a powder form of the composition containing reactive vaterite cement. Drying may be achieved by air-drying the cake. In certain embodiments, drying is achieved by freeze-drying (i.e., lyophilization), wherein the cake is frozen, the surrounding pressure is reduced, and enough heat is added to allow the frozen water in the cake to sublime directly into gas. In yet another embodiment, the cake is spray-dried to dry the cake, wherein the liquid containing the cake is dried by feeding it through a hot gas, and wherein the liquid feed is pumped through an atomizer into a main drying chamber and a hot gas is passed as a co-current or countercurrent to the atomizer direction. Depending on the particular drying protocol of the system, the drying station may include a filtration element, freeze-drying structure, spray-drying structure, etc. In some embodiments, the precipitate may be dried by fluid bed dryer. In certain embodiments, waste heat from a power plant or similar operation may be used to perform the drying step when appropriate.

The composition comprising reactive vaterite cement (optionally including solid from step B as described herein) undergoes transformation to the aragonite and/or the calcite and sets and hardens into cementitious product (shown as product (A) and (B) in FIGS. 2A, 2B, 3A, 3B, 4A, and 4B). In some embodiments, the solid may get incorporated in the cementitious product. This provides an additional advantage of one less step of removal of the solid, minimizing the loss of the N-containing salt, such as e.g., NH₄Cl loss as well as eliminating a potential waste stream thereby increasing the efficiency and improving the economics of the process. In some embodiments, the solid impurities do not adversely affect the transformation and/or reactivity of the vaterite. In some embodiments, the solid impurities do not adversely affect the strength (such as compressive strength or flexural strength) of the cementitious product.

In the systems provided herein, the separation or dewatering step D may be carried out on the separation station. The cake or the precipitate comprising reactive vaterite cement may be stored in the supernatant for a period of time following precipitation and prior to separation. For example, the composition or the precipitate comprising reactive vaterite cement may be stored in the supernatant for a period of time ranging from few min to hours to 1 to 1000 days or longer, such as 1 to 10 days or longer, at a temperature ranging from 1° C. to 40° C., such as 20° C. to 25° C. Separation or dewatering may be achieved using any of a number of convenient approaches, including draining (e.g., gravitational sedimentation of the precipitate comprising reactive vaterite cement followed by draining), decanting, filtering (e.g., gravity filtration, vacuum filtration, filtration using forced air), centrifuging, pressing, or any combination thereof. Separation of the bulk water from the precipitate comprising reactive vaterite cement produces a wet cake of the composition comprising reactive vaterite cement, or a dewatered composition comprising reactive vaterite cement. Liquid-solid separator such as Epuramat's Extrem-Separator (“ExSep”) liquid-solid separator, Xerox PARC's spiral concentrator, or a modification of either of Epuramat's ExSep or Xerox PARC's spiral concentrator, may be useful for the separation of the composition comprising reactive vaterite cement.

In some embodiments, the resultant dewatered composition comprising reactive vaterite cement such as the wet cake material may be directly used to make the product (A) described herein. For example, the wet cake of the composition comprising reactive vaterite cement is mixed with aluminosilicate material, Portland cement clinker, limestone, gypsum, and alkali metal accelerator, as described herein, and is spread out on the conveyer belt where the reactive vaterite cement transforms to the aragonite and/or the calcite and sets and hardens. The hardened material is then cut into desired shapes such as boards or panels described herein. In some embodiments, the wet cake is poured onto a sheet of paper on top of the conveyer belt. Another sheet of paper may be put on top of the wet cake which is then pressed to remove excess water. After the setting and hardening of the reactive vaterite cement (vaterite transformation to the aragonite and/or the calcite), the material is cut into desired shapes, such as, cement siding boards and drywall etc. In some embodiments, the amount of the aluminosilicate material, Portland cement clinker, limestone, gypsum, and alkali metal accelerator or other materials described herein, may be optimized depending on the desired time required for the transformation of the reactive vaterite to the aragonite and/or the calcite. For example, for some applications, it may be desired that the composition transforms rapidly and in certain other instance, a slow transformation may be desired. In some embodiments, the wet cake may be heated on the conveyer belt to hasten the transformation of the reactive vaterite to the aragonite and/or the calcite. In some embodiments, the wet cake may be poured in the molds of desired shape and the molds are then heated in the autoclave to hasten the transformation of the reactive vaterite to the aragonite and/or the calcite. Accordingly, the continuous flow process, batch process or semi-batch process, all are well within the scope of the invention.

In some embodiments, the composition comprising reactive vaterite cement, once separated may be washed with fresh water, and then placed into a filter press to produce a filter cake with 30-60% solids. This filter cake may be then mechanically pressed in a mold, using any convenient means, e.g., a hydraulic press, at adequate pressures, e.g., ranging from 5 to 5000 psi, such as 1000 to 5000 psi, to produce a formed solid, e.g., a rectangular brick. These resultant solids are then cured, e.g., by placing outside and storing, by placing in a chamber wherein they are subjected to high levels of humidity and heat, etc. These resultant cured solids are then used as building materials themselves or crushed to produce aggregate.

In processes involving the use of temperature and pressure, the dewatered cake may be dried. The cake is then exposed to a combination of rewatering, and elevated temperature and/or pressure for a certain time. The combination of the amount of water added back, the temperature, the pressure, and the time of exposure, as well as the thickness of the cake, can be varied according to composition of the starting material and the desired results.

Several different ways of exposing the material to temperature and pressure are described herein; it will be appreciated that any convenient method may be used. Thickness and size of the cake may be adjusted as desired; the thickness can vary in some embodiment from 0.05 inch to 5 inches, e.g., 0.1-2 inches, or 0.3-1 inch. In some embodiments the cake may be 0.5 inch to 6 feet or even thicker. The cake is then exposed to elevated temperature and/or pressure for a given time, by any convenient method, for example, in a platen press using heated platens. The heat to elevate the temperature, e.g., for the platens, may be provided, e.g., by heat from an industrial waste gas stream such as a flue gas stream. The temperature may be any suitable temperature; in general, for a thicker cake a higher temperature is desired; examples of temperature ranges are 40-150° C., e.g., 60-120° C., such as 70-110° C., or 80-100° C. Similarly, the pressure may be any suitable pressure to produce the desired results; exemplary pressures include 1000-100,000 pounds per square inch (psi), including 2000-50,000 psi, or 2000-25,000 psi, or 2000-20,000 psi, or 3000-5000 psi. Finally, the time that the cake is pressed may be any suitable time, e.g., 1-100 seconds, or 1-100 minute, or 1-50 minutes, or 2-25 minutes, or 1-10,000 days. The resultant hard tablet may optionally then cure, e.g., by placing outside and storing, by placing in a chamber wherein they are subjected to high levels of humidity and heat, etc. These hard tablets, optionally cured, are then used as building materials themselves or crushed to produce aggregate.

The methods and systems provided herein produce or isolate the composition containing reactive vaterite cement in a wet form, slurry form, or a dry powder form. This composition containing reactive vaterite cement transforms to the aragonite and/or the calcite form upon dissolution-re-precipitation, setting and hardening. The aragonite form may fully or partially convert further to more stable calcite form. The product from the composition containing reactive vaterite cement shows one or more unexpected properties, including but not limited to, high compressive strength, high porosity (low density or light weight), neutral or near neutral pH (useful as artificial reef described below), microstructure network, etc.

Other minor polymorph forms of calcium carbonate that may be present in the composition containing reactive vaterite cement include, but not limited to, amorphous calcium carbonate, aragonite, calcite, a precursor phase of vaterite, a precursor phase of aragonite, an intermediary phase that is less stable than calcite, polymorphic forms in between these polymorphs or combination thereof.

Vaterite may be present in monodisperse or agglomerated form, and may be in spherical, ellipsoidal, plate like shape, or hexagonal system. Vaterite typically has a hexagonal crystal structure and forms polycrystalline spherical particles upon growth. The precursor form of vaterite comprises nanoclusters of vaterite and the precursor form of aragonite comprises sub-micron to nanoclusters of aragonite needles. Aragonite, if present in the composition along with vaterite, may be needle shaped, columnar, or crystals of the rhombic system. Calcite, if present in the composition along with vaterite, may be cubic, spindle, or crystals of hexagonal system. An intermediary phase that is less stable than calcite may be a phase that is between vaterite and calcite, a phase between precursor of vaterite and calcite, a phase between aragonite and calcite, and/or a phase between precursor of aragonite and calcite.

The transformation between the polymorphs may occur via solid-state transition, may be solution mediated, or both. In some embodiments, the transformation is solution-mediated as it may require less energy than the thermally activated solid-state transition. The reactive vaterite is metastable and the difference in thermodynamic stability of calcium carbonate polymorphs may be manifested as a difference in solubility, where the least stable phases are the most soluble. Applicants have unexpectedly found that the reactive vaterite cement is more than two times soluble in water than limestone thereby increasing the kinetics of the cementation process. Therefore, the reactive vaterite may dissolve readily in solution and transform favorably towards a more stable polymorph, such as the aragonite and/or the calcite. In a polymorphic system like calcium carbonate, two kinetic processes may exist simultaneously in solution:dissolution of the metastable phase and growth of the stable phase. In some embodiments, the aragonite and/or the calcite crystals may be growing while the reactive vaterite is undergoing dissolution in the aqueous medium.

In one aspect, the reactive vaterite may be activated such that the reactive vaterite leads to aragonitic pathway and not calcite pathway during dissolution-re-precipitation process. In some embodiments, the reactive vaterite containing composition is activated in such a way that after the dissolution-re-precipitation process, the aragonite formation is enhanced, and the calcite formation is suppressed. The activation of the reactive vaterite containing composition may result in control over the aragonite formation and crystal growth. The activation of the vaterite containing composition may be achieved by various processes. Various examples of the activation of the reactive vaterite, such as, but not limited to, nuclei activation, thermal activation, mechanical activation, chemical activation, or combination thereof, are described herein. In some embodiments, the reactive vaterite is activated through various processes such that the aragonite and/or the calcite formation and its morphology and/or crystal growth can be controlled upon reaction of the reactive vaterite containing composition with water. The aragonite and/or the calcite formed results in higher tensile strength and fracture tolerance to the products formed from the reactive vaterite.

In some embodiments, the reactive vaterite may be activated by mechanical means, as described herein. For example, the reactive vaterite containing compositions may be activated by creating surface defects on the vaterite composition such that the aragonite formation is accelerated. In some embodiments, the activated vaterite is a ball-milled reactive vaterite or is a reactive vaterite with surface defects such that aragonite and/or calcite formation pathway is facilitated.

The reactive vaterite containing compositions may also be activated by providing chemical or nuclei activation to the vaterite composition. Such chemical or nuclei activation may be provided by one or more of aragonite seeds, inorganic additive, or organic additive. The aragonite seed present in the compositions provided herein may be obtained from natural or synthetic sources. The natural sources include, but not limited to, reef sand, lime, hard skeletal material of certain fresh-water and marine invertebrate organisms, including pelecypods, gastropods, mollusk shell, and calcareous endoskeleton of warm- and cold-water corals, pearls, rocks, sediments, ore minerals (e.g., serpentine), and the like. The synthetic sources include, but not limited to, precipitated aragonite, such as formed from sodium carbonate and calcium chloride; or aragonite formed by the transformation of the reactive vaterite to aragonite, such as transformed reactive vaterite described herein.

In some embodiments, the inorganic additive or the organic additive in the compositions provided herein can be any additive that activates reactive vaterite. Some examples of inorganic additive or organic additive in the composition provided herein, include, but not limited to, sodium decyl sulfate, lauric acid, sodium salt of lauric acid, urea, citric acid, sodium salt of citric acid, phthalic acid, sodium salt of phthalic acid, taurine, creatine, dextrose, poly(n-vinyl-1-pyrrolidone), aspartic acid, sodium salt of aspartic acid, magnesium chloride, acetic acid, sodium salt of acetic acid, glutamic acid, sodium salt of glutamic acid, strontium chloride, gypsum, lithium chloride, sodium chloride, glycine, sodium citrate dehydrate, sodium bicarbonate, magnesium sulfate, magnesium acetate, sodium polystyrene, sodium dodecylsulfonate, poly-vinyl alcohol, or combination thereof. In some embodiments, inorganic additive or organic additive in the composition provided herein, include, but not limited to, taurine, creatine, poly(n-vinyl-1-pyrrolidone), lauric acid, sodium salt of lauric acid, urea, magnesium chloride, acetic acid, sodium salt of acetic acid, strontium chloride, magnesium sulfate, magnesium acetate, or combination thereof. In some embodiments, inorganic additive or organic additive in the compositions provided herein, include, but not limited to, magnesium chloride, magnesium sulfate, magnesium acetate, or combination thereof.

Without being limited by any theory, it is contemplated that the activation of the reactive vaterite by ball-milling or by addition of aragonite seed, inorganic additive or organic additive or combination thereof may result in control of formation of the aragonite and/or the calcite during dissolution-re-precipitation process of the activated reactive vaterite including control of properties, such as, but not limited to, polymorph, morphology, particle size, cross-linking, agglomeration, coagulation, aggregation, sedimentation, crystallography, inhibiting growth along a certain face of a crystal, allowing growth along a certain face of a crystal, or combination thereof. For example, the aragonite seed, inorganic additive or organic additive may selectively target the morphology of aragonite, inhibit calcite growth and promote the formation of aragonite that may generally not be favorable kinetically.

In some embodiments, in the foregoing methods, the amount of the one or more additives added during the process is more than 0.1% by weight, or more than 0.5% by weight, or more than 1% by weight, or more than 2% by weight, or more than 3% by weight, or more than 4% by weight, or between 0.5-3% by weight or between 1.5-2.5% by weight.

In some embodiments, the compositions comprising reactive vaterite cement upon combination with water, setting, and hardening, have a compressive strength of at least 3 MPa (megapascal), or at least 7 MPa, or at least 10 MPa or in some embodiments, between 3-30 MPa, or between 14-80 MPa or 14-35 MPa.

In the aspects provided herein, the methods comprise blending the composition comprising reactive vaterite cement with the SCM comprising aluminosilicate material. The aluminosilicate materials have been described herein in detail and include, without limitation, heat-treated clay, natural or artificial pozzolan, shale, granulated blast furnace slag, or combination thereof. In some embodiments, the methods further comprise heating the clay material at a temperature between 500-1100° C. to produce the heat-treated clay material before its blending with the composition comprising reactive vaterite cement. In some embodiments, the heat-treated clay material may be ground before the blending.

In some embodiments, the methods further comprise mixing or blending the carbonate material with the aluminosilicate material before the blending with the composition comprising reactive vaterite cement. The carbonate materials have been described herein. It is to be understood that the carbonate material, such as e.g., limestone may be mixed with the composition comprising reactive vaterite cement or the aluminosilicate material. In some embodiments, the methods further comprise grinding the carbonate material to a specific surface area of 100-3,000 m²/kg before the mixing with the composition comprising reactive vaterite cement and/or the aluminosilicate material.

In some embodiments, the methods further comprise mixing Portland cement clinker with the aluminosilicate material before the blending with the composition comprising reactive vaterite cement. The Portland cement clinker has been described herein. It is to be understood that the Portland cement clinker may be mixed with the composition comprising reactive vaterite cement, the carbonate material and/or the aluminosilicate material. The order of the addition of these components may vary.

In some embodiments, the methods further comprise adding water to the cement blend composition and transforming the reactive vaterite cement to the aragonite cement and/or the calcite upon dissolution and re-precipitation in water. The reactive vaterite cement has more than two times the solubility of limestone in water which results in faster kinetics and cementation and higher early compressive strengths. In some embodiments, the addition of the water results in the reaction of the reactive vaterite cement with the aluminosilicate material to form carboaluminate hydrate comprising monocarboaluminate, hemicarboaluminate, or combination thereof. Without being limited by any theory, Applicants contemplate that the chemical reaction between the reactive vaterite and the aluminosilicate material results in the formation of the carboaluminate hydrate which adds to the high compressive strength of the cement product.

In some embodiments, the reactive vaterite cement composition further comprises magnesium oxide which in the presence of water transforms to magnesium hydroxide. In some embodiments, the magnesium hydroxide binds with the aragonite and/or the calcite resulting in the high compressive strength of the cement product.

During the blending or the mixing of the blend composition comprising reactive vaterite cement with other components as mentioned herein and mixing with the aqueous medium, the blend composition may be subjected to high shear mixer. After mixing, the blend composition may be dewatered again and placed in pre-formed molds to make formed building materials or may be used to make formed building materials using the processes well known in the art or as described herein. Alternatively, the blend composition may be mixed with water and may be allowed to set. The blend composition may set over a period of days and may be then placed in the oven for drying, e.g., at 40° C., or from 40° C.-60° C., or from 40° C.-50° C., or from 40° C.-100° C., or from 50° C.-60° C., or from 50° C.-80° C., or from 50° C.-100° C., or from 60° C.-80° C., or from 60° C.-100° C. The blend composition may be subjected to curing at high temperature, such as, from 50° C.-60° C., or from 50° C.-80° C., or from 50° C.-100° C., or from 60° C.-80° C., or from 60° C.-100° C., or 60° C., or 80° C.-100° C., in high humidity, such as, in 40%, or 50%, or 60%, or 70%, or 90%, or 98% humidity.

The product produced by the methods described herein may be an aggregate or building material or a pre-cast material or a formed building material. In some embodiments, the product produced by the methods described herein includes artificial reef. These products have been described herein.

The components of the blend composition can be combined using any suitable protocol. Each material may be mixed at the time of work, or part of or all of the materials may be mixed in advance. Alternatively, some of the materials are mixed with water with or without admixtures, such as high-range water-reducing admixture, and then the remaining materials may be mixed therewith. As a mixing apparatus, any conventional apparatus can be used. For example, Hobart mixer, slant cylinder mixer, Omni Mixer, Henschel mixer, V-type mixer, and Nauta mixer can be employed.

In one aspect, there are provided systems to form the composition, comprising (i) a calcination reactor configured for calcining the limestone to form the mixture comprising lime and the gaseous stream of carbon dioxide; (ii) a dissolution reactor operably connected to the calcination reactor configured for dissolving the mixture comprising lime in the aqueous N-containing salt solution to produce the aqueous solution comprising calcium salt; (iii) a treatment reactor operably connected to the dissolution reactor configured for treating the aqueous solution comprising calcium salt with the gaseous stream comprising carbon dioxide to form the composition comprising reactive vaterite cement; and (iv) a blending reactor operably connected to the treatment reactor configured for blending the supplementary cementitious material (SCM) comprising aluminosilicate material with the reactive vaterite cement composition to produce the cement blend composition.

In one aspect, there are provided systems to form the composition, comprising (i) a dissolution reactor configured for dissolving the limestone in the aqueous N-containing salt solution to produce the aqueous solution comprising calcium salt and the gaseous stream comprising carbon dioxide; (ii) a treatment reactor operably connected to the dissolution reactor configured for treating the aqueous solution comprising calcium salt with the gaseous stream comprising carbon dioxide to form the composition comprising reactive vaterite cement; and (iii) a blending reactor operably connected to the treatment reactor configured for blending the supplementary cementitious material (SCM) comprising aluminosilicate material with the reactive vaterite cement composition to produce the cement blend composition.

In one aspect, there are provided systems to form the composition, comprising (i) a calcination reactor configured for calcining the limestone to form the mixture comprising lime and the gaseous stream of carbon dioxide; (ii) a dissolution reactor operably connected to the calcination reactor configured for dissolving the mixture comprising lime in the aqueous N-containing salt solution to produce the first aqueous solution comprising calcium salt and the gaseous stream comprising ammonia; (iii) a cooling reactor configured for recovering the gaseous stream comprising carbon dioxide and the gaseous stream comprising ammonia and subjecting the gaseous stream to a cooling process to condense the second aqueous solution comprising ammonium bicarbonate, ammonium carbonate, ammonia, ammonia carbamate, or combination thereof; (iv) a treatment reactor operably connected to the dissolution reactor and the cooling reactor configured for treating the first aqueous solution with the second aqueous solution to form the composition comprising reactive vaterite cement; and (v) a blending reactor operably connected to the treatment reactor configured for blending the supplementary cementitious material (SCM) comprising aluminosilicate material with the reactive vaterite cement composition to produce the cement blend composition.

In one aspect, there are provided systems to form the composition, comprising (i) a dissolution reactor configured for dissolving the limestone in the aqueous N-containing salt solution to produce the first aqueous solution comprising calcium salt, the gaseous stream comprising carbon dioxide, and the gaseous stream comprising ammonia; (ii) a cooling reactor configured for recovering the gaseous stream comprising carbon dioxide and the gaseous stream comprising ammonia and subjecting the gaseous stream to a cooling process to condense the second aqueous solution comprising ammonium bicarbonate, ammonium carbonate, ammonia, ammonia carbamate, or combination thereof; (iii) a treatment reactor operably connected to the dissolution reactor and the cooling reactor configured for treating the first aqueous solution with the second aqueous solution to form the composition comprising reactive vaterite cement; and (iv) a blending reactor operably connected to the treatment reactor configured for blending the supplementary cementitious material (SCM) comprising aluminosilicate material with the reactive vaterite cement composition to produce the cement blend composition.

In some embodiments of the aforementioned aspect and embodiments, the dissolution reactor is integrated with the cooling reactor.

In some embodiments of the aforementioned aspects and embodiments, the system further comprises a recovering system to recover the N-containing salt from the aqueous solution to be recycled back to the dissolution reactor. The recovering system is the system configured to carry out thermal decomposition, reverse osmosis, multi-stage flash, multi-effect distillation, vapor recompression, distillation, and combinations thereof, as described herein above.

The methods and systems provided herein may be carried out at land (e.g., at a location close to the limestone quarry, or is easily and economically transported in), at sea, or in the ocean. In some embodiments, the cement plants calcining the lime may be retro-fitted with the systems described herein to form the blended compositions and further to form products.

Aspects include systems, including processing plants or factories, for practicing the methods as described herein. Systems may have any configuration that enables practice of the particular production method of interest.

In certain embodiments, the systems include a source of limestone and a structure having an input for the aqueous N-containing salt solution. For example, the systems may include a pipeline or analogous feed of aqueous solution, wherein the aqueous solution is as described herein. The system further includes an input for CO₂ as well as components for combining these sources with water (optionally an aqueous solution such as water, brine, or seawater) before the precipitation reactor or in the precipitation reactor. In some embodiments, the gas-liquid contactor is configured to contact enough CO₂ to produce the composition in excess of 1, 10, 100, 1,000, or 10,000 tons per day.

The systems further include a precipitation reactor that subjects the water introduced to the precipitation reactor to the one or more precipitation conditions (as described herein) and produces the composition and supernatant. In some embodiments, the precipitation reactor is configured to hold water sufficient to produce the composition in excess of 1, 10, 100, 1,000, or 10,000 tons per day. The precipitation reactor may also be configured to include any of a number of different elements such as temperature modulation elements (e.g., configured to heat the water to a desired temperature), chemical additive elements (e.g., configured for introducing additives etc. into the precipitation reaction mixture), computer automation, and the like.

The gaseous waste stream comprising CO₂ and optionally NH₃ may be provided to the precipitation reactor and/or the cooling reactor in any convenient manner. In some embodiments, the gaseous waste stream is provided with a gas conveyer (e.g., a duct) that runs from the dissolution reactor to the precipitation reactor and/or the cooling reactor.

Where the water source that is processed by the system to produce the precipitation material is seawater, the input is in fluid communication with a source of sea water, e.g., such as where the input is a pipeline or feed from ocean water to a land-based system or an inlet port in the hull of ship, e.g., where the system is part of a ship, e.g., in an ocean-based system.

The methods and systems may also include one or more detectors configured for monitoring the aqueous N-containing salt solution, the lime, the limestone, and/or the carbon dioxide (not illustrated in figures). Monitoring may include, but is not limited to, collecting data about the pressure, temperature and composition of the water or the carbon dioxide gas. The detectors may be any convenient device configured to monitor, for example, pressure sensors (e.g., electromagnetic pressure sensors, potentiometric pressure sensors, etc.), temperature sensors (resistance temperature detectors, thermocouples, gas thermometers, thermistors, pyrometers, infrared radiation sensors, etc.), volume sensors (e.g., geophysical diffraction tomography, X-ray tomography, hydroacoustic surveyers, etc.), and devices for determining chemical makeup of the water or the carbon dioxide gas (e.g., IR spectrometer, NMR spectrometer, UV-vis spectrophotometer, high performance liquid chromatographs, inductively coupled plasma emission spectrometers, inductively coupled plasma mass spectrometers, ion chromatographs, X-ray diffractometers, gas chromatographs, gas chromatography-mass spectrometers, flow-injection analysis, scintillation counters, acidimetric titration, and flame emission spectrometers, etc.).

In some embodiments, detectors may also include a computer interface which is configured to provide a user with the collected data about the aqueous N-containing salt solution, the lime, the limestone, and/or the carbon dioxide/ammonia gas. In some embodiments, the summary may be stored as a computer readable data file or may be printed out as a user readable document.

In some embodiments, the detector may be a monitoring device such that it can collect real-time data (e.g., internal pressure, temperature, etc.). In other embodiments, the detector may be one or more detectors configured to determine the parameters at regular intervals, e.g., determining the composition every 1 minute, every 5 minutes, every 10 minutes, every 30 minutes, every 60 minutes, every 100 minutes, every 200 minutes, every 500 minutes, or some other interval.

In certain embodiments, the system may further include a station for preparing a building material, such as cement or aggregate, from the composition. Other materials such as formed building materials may also be formed from the composition and appropriate station may be used for preparing the same.

As indicated above, the system may be present on land or sea. For example, the system may be land-based system that is in a coastal region, e.g., close to a source of seawater, or even an interior location, where water is piped into the system from a water source, e.g., ocean. Alternatively, the system is a water-based system, i.e., a system that is present on or in water. Such a system may be present on a boat, ocean-based platform etc., as desired.

Calcium carbonate slurry may be pumped via pump to drying system, which in some embodiments includes a filtration step followed by spray drying. The water separated from the drying system is discharged or is recirculated to the reactor. The resultant solid or powder from the drying system is the composition comprising reactive vaterite cement utilized as cement or aggregate to produce building materials. The solid or powder may also be used in forming formed building materials, such as drywall, cement boards, etc.

In some embodiments, the systems may include a control station, configured to control the amount of the aqueous N-containing salt solution and/or the amount of the lime or limestone conveyed to the precipitator or the dissolution reactor; the amount of the precipitate conveyed to the separator; the amount of the precipitate conveyed to the drying station; and/or the amount of the precipitate conveyed to the refining station. A control station may include a set of valves or multi-valve systems which are manually, mechanically, or digitally controlled, or may employ any other convenient flow regulator protocol. In some instances, the control station may include a computer interface, (where regulation is computer-assisted or is entirely controlled by computer) configured to provide a user with input and output parameters to control the amount, as described above.

### III. Products

Examples of various cement and concrete products comprising the aragonite cement or calcite and the carboaluminate hydrate formed from the composition comprising reactive vaterite cement and aluminosilicate material, have been provided herein. The product (product (A) or (B) in the figures) containing the aragonite and/or calcite form of the precipitate (aragonite and/or calcite formed by the dissolution-re-precipitation of the reactive vaterite) along with the formation of the carboaluminate hydrate (optionally further comprising magnesium hydroxide), shows one or more unexpected properties, including but not limited to, high compressive strength, low porosity or permeability, high porosity (low density or light weight), microstructure network, low CO₂ emissions, etc.

One example of the cement or the concrete product formed from the compositions provided herein, is a building material. The “building material” used herein includes material used in construction. In one aspect, there is provided a structure, or a building material made from the set and hardened form of the cement composition comprising reactive vaterite cement and SCM comprising aluminosilicate material e.g., where the reactive vaterite has converted to the aragonite and/or the calcite that sets and hardens. As described herein, the composition further comprises one or more other components and/or other SCM materials, such as, but not limited to, Portland cement clinker, carbonate material, calcium sulfate, alkali metal accelerator, additive, admixture, etc. Examples of such structures or the building materials include, but are not limited to, building, driveway, foundation, kitchen slab, furniture, pavement, road, bridges, motorway, overpass, parking structure, brick, block, wall, footing for a gate, fence, or pole, and combination thereof.

One example of the cement or the concrete product formed from the compositions provided herein, is a formed building material. The “formed building material” used herein includes materials shaped (e.g., molded, cast, cut, or otherwise produced) into structures with defined physical shape. In one aspect, there is provided a formed building material made from the set and hardened form of the cement composition comprising reactive vaterite cement and SCM comprising aluminosilicate material e.g., where the reactive vaterite has converted to the aragonite and/or the calcite that sets and hardens. As described herein, the composition further comprises one or more other components and/or other SCM materials, such as, but not limited to, Portland cement clinker, carbonate material, calcium sulfate, alkali metal accelerator, additive, admixture, etc.

The formed building material may be a pre-cast building material, such as, a pre-cast cement or concrete product. The formed building material and the method of making and using the formed building material are described in U.S. application Ser. No. 12/571,398, filed Sep. 30, 2009, which is incorporated herein by reference in its entirety. The formed building material may vary greatly and include material shaped (e.g., molded, cast, cut, or otherwise produced) into structures with defined physical shape, i.e., configuration. Formed building material is distinct from amorphous building material (e.g., powder, paste, slurry, etc.) that does not have a defined and stable shape, but instead conforms to the container in which it is held, e.g., a bag or other container. Formed building materials are also distinct from irregularly or imprecisely formed materials (e.g., aggregate, bulk forms for disposal, etc.) in that formed building materials are produced according to specifications that allow for use of formed building materials in, for example, buildings. Formed building materials may be prepared in accordance with traditional manufacturing protocols for such structures, with the exception that the compositions provided herein are employed in making such materials.

In some embodiments, the formed building materials made from the compositions provided herein have a compressive strength or the flexural strength of at least 3 MPa, at least 10 MPa, or at least 14 MPa, or between 3-30 MPa, or between about 14-100 MPa, or between about 14-45 MPa; or the compressive strength of the compositions provided herein after setting, and hardening, as described herein.

Examples of the formed building materials that can be produced by the foregoing methods and systems, include, but not limited to, masonry unit, for example only, brick, block, and tile including, but not limited to, ceiling tile; construction panel, for example only, cement board (boards traditionally made from cement such as fiber cement board) and/or drywall (boards traditionally made from gypsum); conduit; basin; beam; column, slab; acoustic barrier; insulation material; or combination thereof. Construction panels are formed building materials employed in a broad sense to refer to any non-load-bearing structural element that are characterized such that their length and width are substantially greater than their thickness. As such the panel may be a plank, a board, shingles, and/or tiles. Exemplary construction panels formed from the precipitation material provided herein include cement board and/or drywall. Construction panels are polygonal structures with dimensions that vary greatly depending on their intended use. The dimensions of construction panels may range from 50 to 500 cm in length, including 100 to 300 cm, such as 250 cm; width ranging from 25 to 200 cm, including 75 to 150 cm, such as 100 cm; thickness ranging from 5 to 25 mm, including 7 to 20 mm, including 10 to 15 mm.

In some embodiments, the cement board and/or the drywall may be used in making different types of boards such as, but not limited to, paper-faced board (e.g. surface reinforcement with cellulose fiber), fiberglass-faced or glass mat-faced board (e.g. surface reinforcement with glass fiber mat), fiberglass mesh reinforced board (e.g. surface reinforcement with glass mesh), and/or fiber-reinforced board (e.g. cement reinforcement with cellulose, glass, fiber etc.). These boards may be used in various applications including, but not limited to, sidings such as, fiber-cement siding, roofing, soffit, sheathing, cladding, decking, ceiling, shaft liner, wall board, backer, trim, frieze, shingle, and fascia, and/or underlayment. The cement boards made by the methods and systems provided herein are made from the compositions provided herein that partially or wholly replaces the traditional Portland cement in the board. In some embodiments, the cement boards may comprise construction panels prepared as a combination of the aragonitic and/or calcite (setting and hardening when the reactive vaterite transforms to the aragonite and/or calcite) and fiber and/or fiberglass and may possess additional fiber and/or fiberglass reinforcement at both faces of the board. The cement boards are formed building materials which in some embodiments, are used as backer boards for ceramics that may be employed behind bathroom tiles, kitchen counters, backsplashes, etc. and may have lengths ranging from 100 to 200 cm. Cement boards may vary in physical and mechanical properties. In some embodiments, the flexural strength may vary, ranging between 1 to 7.5 MPa, including 2 to 6 MPa, such as 5 MPa. The compressive strengths may also vary, ranging from 5 to 50 MPa, including 10 to 30 MPa, such as 15 to 20 MPa. In some embodiments, cement boards may be employed in environments having extensive exposure to moisture (e.g., commercial saunas). In addition, a variety of further components may be added to the cement boards which include, but are not limited to, plasticizers, clay, foaming agents, accelerators, retarders, and air entrainment additives. The composition is then poured out into sheet molds, or a roller may be used to form sheets of a desired thickness. The shaped composition may be further compacted by roller compaction, hydraulic pressure, vibrational compaction, or resonant shock compaction. The sheets are then cut to the desired dimensions of the cement boards.

Another type of construction panel formed from the compositions described herein is backer board. The backer board may be used for the construction of interior, and/or exterior floors, walls, and ceilings. In the embodiments, the backer board is made partially or wholly from the compositions provided herein. Another type of construction panel formed from the compositions provided herein is drywall. The drywall includes board that is used for construction of interior, and/or exterior floors, walls, and ceilings. Traditionally, drywall is made from gypsum (called paper-faced board). In some embodiments, the drywall is made partially or wholly from the compositions provided herein thereby replacing gypsum from the drywall product. In some embodiments, the drywall may comprise construction panels prepared as a combination of aragonitic cement and/or calcite (setting and hardening when vaterite transforms to aragonite and/or calcite) and cellulose, fiber and/or fiberglass and may possess additional paper, fiber, fiberglass mesh and/or fiberglass mat reinforcement at both faces of the board. Various processes for making the drywall product are well known in the art and are well within the scope of the invention. Some examples include, but not limited to, wet process, semi dry process, extrusion process, Wonderborad® process, etc., that have been described herein. In some embodiments, the drywall is panel made of a paper liner wrapped around an inner core. For example, in some embodiments, during the process of making the drywall product from the compositions provided herein, the slurry of the compositions provided herein is poured over a sheet of paper. Another sheet of paper is then put on top of the slurry such that the slurry is flanked by the paper on both sides (the resultant composition sandwiched between two sheets of outer material, e.g., heavy paper or fiberglass mats). The reactive vaterite in the compositions provided herein is then transformed to aragonite and/or calcite (using additives and/or heat) which then sets and hardens along with the formation of the carboaluminate hydrates. When the core sets and is dried in a large drying chamber, the sandwich becomes rigid and strong enough for use as a building material. The drywall sheets are then cut and separated.

The flexural and compressive strengths of the drywall formed from the compositions provided herein are equal to or higher than conventional drywall prepared with gypsum plaster, which is known to be a soft construction material. In some embodiments, the flexural strength may range between 0.1 to 3 MPa, including 0.5 to 2 MPa, such as 1.5 MPa. The compressive strengths may also vary, in some instances ranging from 1 to 20 MPa, including 5 to 15 MPa, such as 8 to 10 MPa. In some embodiments, the formed building materials such as, the construction panels such as, but not limited to, cement boards and drywall produced by the methods and systems described herein, have low density and high porosity making them suitable for lightweight and insulation applications. The high porosity and light weight of the formed building materials such as construction panels may be due to the development of the aragonitic and/or calcitic microstructure along with the formation of the carboaluminate hydrates when the reactive vaterite transforms to aragonite and/or calcite in the presence of the aluminosilicate material. The transformation of the reactive vaterite during dissolution/re-precipitation process may lead to micro porosity generation while at the same time the voids created between the aragonitic crystals formed may provide nano porosity thereby leading to highly porous and light weight structure. Certain admixtures may be added during the transformation process such as, but not limited to, foaming agents, rheology modifiers and mineral extenders, such as, but not limited to, clay, starch, etc. which may add to the porosity in the product as the foaming agent may entrain air in the mixture and lower the overall density and mineral extender such as sepiolite clay may increase the viscosity of the mixture thereby preventing segregation of the precipitation material and water.

One of the applications of the cement board or drywall is fiber cement siding. Fiber-cement sidings formed by the methods and systems provided herein comprise construction panels prepared as a combination of aragonitic cement and/or calcite along with carboaluminate hydrates, aggregate, interwoven cellulose, and/or polymeric fibers and may possess a texture and flexibility that resembles wood.

In some embodiments, the formed building materials are masonry units. Masonry units are formed building materials used in the construction of load-bearing and non-load-bearing structures that are generally assembled using mortar, grout, and the like. Exemplary masonry units formed from the compositions include bricks, blocks, and tiles.

Another formed building material formed from the compositions described herein is a conduit. Conduits are tubes or analogous structures configured to convey a gas or liquid, from one location to another. Conduits can include any number of different structures used in the conveyance of a liquid or gas that include, but are not limited to, pipes, culverts, box culverts, drainage channels and portals, inlet structures, intake towers, gate wells, outlet structures, and the like.

Another formed building material formed from the compositions described herein is basins. The term basin may include any configured container used to hold a liquid, such as water. As such, a basin may include, but is not limited to structures such as wells, collection boxes, sanitary manholes, septic tanks, catch basins, grease traps/separators, storm drain collection reservoirs, etc.

Another formed building material formed from the compositions described herein is a beam, which, in a broad sense, refers to a horizontal load-bearing structure possessing large flexural and compressive strengths. Beams may be rectangular cross-shaped, C-channel, L-section edge beams, I-beams, spandrel beams, H-beams, possess an inverted T-design, etc. Beams may also be horizontal load-bearing units, which include, but are not limited to joists, lintels, archways and cantilevers.

Another formed building material formed from the compositions described herein is a column, which, in a broad sense, refers to a vertical load-bearing structure that carries loads chiefly through axial compression and includes structural elements such as compression members. Other vertical compression members of the invention may include, but are not limited to pillars, piers, pedestals, or posts.

Another formed building material formed from the compositions described herein is a concrete slab. Concrete slabs are those building materials used in the construction of prefabricated foundations, floors, and wall panels. In some instances, a concrete slab may be employed as a floor unit (e.g., hollow plank unit or double tee design).

Another formed building material formed from the compositions described herein is an acoustic barrier, which refers to a structure used as a barrier for the attenuation or absorption of sound. As such, an acoustic barrier may include, but is not limited to, structures such as acoustical panels, reflective barriers, absorptive barriers, reactive barriers, etc.

Another formed building material formed from the compositions described herein is an insulation material, which refers to a material used to attenuate or inhibit the conduction of heat. Insulation may also include those materials that reduce or inhibit radiant transmission of heat.

In some embodiments, the other formed building materials such as pre-cast concrete products include, but not limited to, bunker silo; cattle feed bunk; cattle grid; agricultural fencing; H-bunks; J-bunks; livestock slats; livestock watering troughs; architectural panel walls; cladding (brick); building trim; foundation; floors, including slab on grade; walls; double wall precast sandwich panel; aqueducts; mechanically stabilized earth panels; box culverts; 3-sided culverts; bridge systems; RR crossings; RR ties; sound walls/barriers; Jersey barriers; tunnel segments; reinforced concrete box; utillity protection structure; hand holes; hollowcore product; light pole base; meter box; panel vault; pull box; telecom structure; transformer pad; transformer vault; trench; utility vault; utility pole; controlled environment vaults; underground vault; mausoleum; grave stone; coffin; haz mat storage container; detention vaults; catch basins; manholes; aeration system; distribution box; dosing tank; dry well; grease interceptor; leaching pit; sand-oil/oil-water interceptor; septic tank; water/sewage storage tank; wetwells; fire cisterns; floating dock; underwater infrastructure; decking; railing; sea walls; roofing tiles; pavers; community retaining wall; res. retaining wall; modular block systems; and segmental retaining walls.

In some embodiments, the methods described herein include making artificial marine structures from the compositions described herein including, but not limited to, artificial corals and reefs. In some embodiments, the artificial structures can be used in the aquariums or sea. In some embodiments, the aragonitic cement and/or calcite provides neutral or close to neutral pH which may be conducive for maintenance and growth of marine life. The aragonitic reefs may provide suitable habitat for marine species.

Throughout the description, where compositions are described as having, including, or comprising specific components, or where processes and methods are described as having, including, or comprising specific steps, it is contemplated that, additionally, there are compositions of the present invention that consist essentially of, or consist of, the recited components, and that there are processes and methods according to the present invention that consist essentially of, or consist of, the recited processing steps.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition or a process described herein can be combined in a variety of ways without departing from the spirit and scope of the present invention, whether explicit or implicit herein. For example, where reference is made to a particular composition, that composition can be used in various embodiments of compositions of the present invention and/or in processes of the present invention, unless otherwise understood from the context. In other words, within this application, embodiments have been described and depicted in a way that enables a clear and concise application to be written and drawn, but it is intended and will be appreciated that embodiments may be variously combined or separated without parting from the present teachings and invention(s). For example, it will be appreciated that all features described and depicted herein can be applicable to all aspects of the invention(s) described and depicted herein.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

The use of any and all examples, or exemplary language herein, for example, “such as” or “including,” is intended merely to illustrate better the present invention and does not pose a limitation on the scope of the invention unless claimed. No language in the specification should be construed as indicating any non-claimed element as essential to the practice of the present invention.

Certain ranges are presented herein with numerical values being preceded by the term “about.” The term “about” is used herein to provide literal support for the exact number that it precedes, as well as a number that is near to or approximately the number that the term precedes. As used herein, the term “about” refers to a ±10% variation from the nominal value unless otherwise indicated or inferred.

Unless defined otherwise, all technical and scientific terms used herein have the same meaning as commonly understood by one of ordinary skill in the art to which this invention belongs. Although any processes and materials similar or equivalent to those described herein can also be used in the practice or testing of the invention, representative illustrative processes and materials are described herein.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It should be understood that the expression “at least one of” includes individually each of the recited objects after the expression and the various combinations of two or more of the recited objects unless otherwise understood from the context and use. The expression “and/or” in connection with three or more recited objects should be understood to have the same meaning unless otherwise understood from the context.

It is noted that, as used herein and in the appended claims, the singular forms “a”, “an”, and “the” include plural references unless the context clearly dictates otherwise. For example, where the plural form is used for compounds, salts, and the like, this is taken to mean also a single compound, salt, or the like. It is further noted that the claims may be drafted to exclude any optional element.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited process can be carried out in the order of events recited or in any other order, which is logically possible. It should be understood that the order of steps or order for performing certain actions is immaterial so long as the present invention remain operable. Moreover, two or more steps or actions may be conducted simultaneously.

The following examples are put forth to provide those of ordinary skill in the art with a complete disclosure and description of how to make and use the invention and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for.

### EXAMPLES

### Example 1

### Effect of the Substitution of the Portland Cement Clinker with the Reactive Vaterite in the Blend Composition

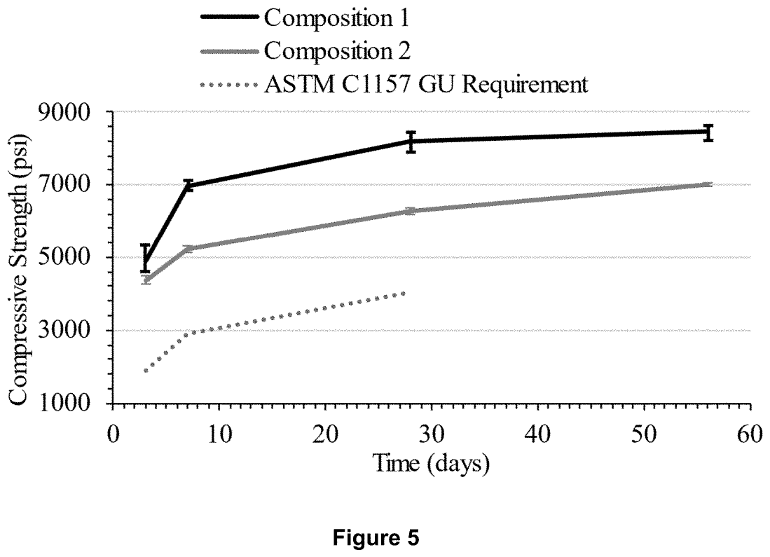

A blended cement (composition 1) was created by combining type IL(10) Portland limestone cement, the calcined clay, and the reactive vaterite cement, see Table I. The blended cement was compared to the same Portland limestone cement (composition 2) used to make the blend as a baseline comparison. The blended cement was homogenized until uniform prior to mixing mortars. Mortars were then mixed according to ASTM C305 with a sand to cement ratio of 2.75:1 and water to cement ratio of 0.485:1. Two-inch mortar cubes were cast in brass molds and cured for 24 hours at 23° C. and 98% relative humidity. After 24 hours, the cubes were demolded and tested for compressive strength at 1 day. The remaining cubes were stored at 21° C. in a saturated lime bath until testing at 3, 7, and 28 days. The loading rate utilized for compressive strength testing was 300 lb/sec. FIG. 5 illustrates the compressive strength results where the compressive strength of the composition 1 showed higher compressive strength than the compressive strength of the composition 2.

TABLE I
Blended cement composition

| Blended | | | Reactive | Ground | |
|---|---|---|---|---|---|
| Cement | | Cement | Vaterite | Calcium | Calcined |
| Composition | Cement | (Type) | Cement | Carbonate | Clay |
| 1 | 50.0% | IL(10) | 25.0% | — | 25.0% |
| 2 | 100.0% | IL(10) | — | — | — |

### Example 2

### Effect of the Substitution of the Ground Limestone with the Reactive Vaterite in the Blend Composition

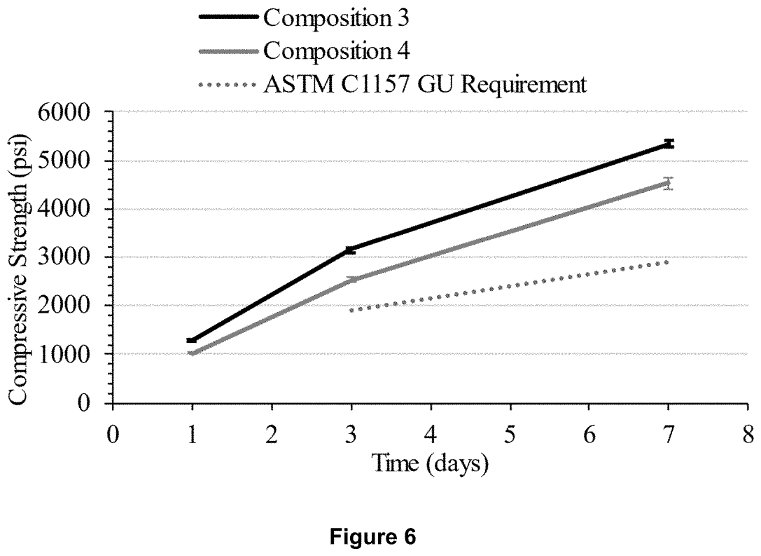

Blended cements were created by combining type II/V Portland cement, calcined clay, gypsum, and reactive vaterite cement or ground calcium carbonate (GCC), see Table II. Composition 4 comprised type II/V Portland cement, calcined clay, gypsum, and GCC whereas composition 3 substituted the GCC with the reactive vaterite cement and comprised type II/V Portland cement, calcined clay, gypsum, and reactive vaterite cement. The blended cements were homogenized until uniform prior to mixing mortars. Mortars were then mixed according to ASTM C305 with a sand to cement ratio of 2.75:1 and water to cement ratio of 0.485:1. Two-inch mortar cubes were cast in brass molds and cured for 24 hours at 23° C. and 98% relative humidity. After 24 hours, the cubes were demolded and tested for compressive strength at 1 day. The remaining cubes were stored at 21° C. in a saturated lime bath until testing at 3 and 7 days. The loading rate utilized for compressive strength testing was 300 lb/sec. FIG. 6 illustrates the compressive strength results showing that the blended cement containing reactive vaterite cement (composition 3) outperformed the traditional limestone calcined clay cement (composition 4).

TABLE II
Blended cement composition

| Blended | | | | | | |
|---|---|---|---|---|---|---|
| Cement | | | | Ground | | |
| Composi- | | Cement | Vaterite | Calcium | Calcined | |
| tion | Cement | (Type) | Cement | Carbonate | Clay | Gypsum |
| 3 | 38.5% | II/V | 20.0% | — | 40.0% | 1.5% |
| 4 | 38.5% | II/V | — | 20.0% | 40.0% | 1.5% |

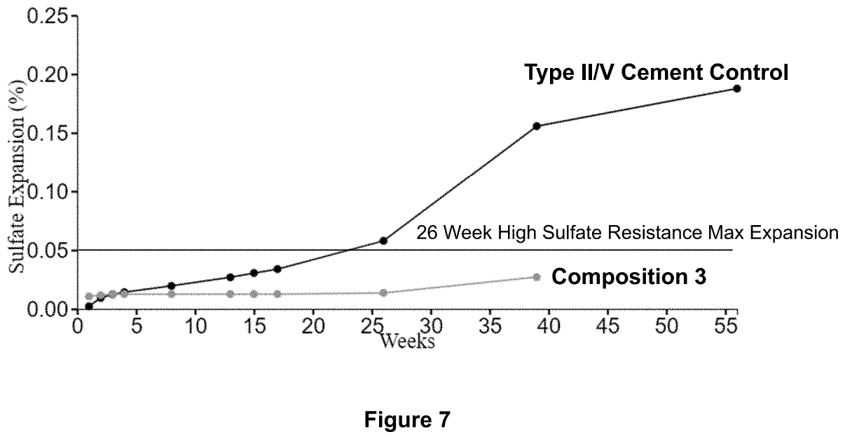

Applicants also discovered that the addition of the reactive vaterite cement to the type WV Portland cement increased the sulfate resistance of the blended cement. FIG. 7 illustrates the increased sulfate resistance of the blended cement containing the reactive vaterite cement (composition 3) and its outperformance compared to the traditional type II/V Portland cement, which is intended to be highly sulfate resistant.

### Example 3

### Effect of the Alkali Metal Accelerator or Alkaline Earth Metal Accelerator on the Compressive Strength of the Blend Composition

Blended cements were created by combining 60% type IL(10) Portland limestone cement, 20% calcined clay, 20% reactive vaterite cement, and a variable amount of alkali metal or alkaline earth metal accelerators as an addition based on the cementitious material (CM), see Table III. The blended cements were homogenized until uniform prior to mixing mortars. Mortars were then mixed according to ASTM C305 with a sand to cement ratio of 2.75:1 and water to cement ratio of 0.485:1. Two-inch mortar cubes were cast in brass molds and cured for 24 hours at 23° C. and 98% relative humidity. After 24 hours, the cubes were demolded and stored at 21° C. in a saturated lime bath until testing at 3 days. The loading rate utilized for compressive strength testing was 300 lb/sec. Table III demonstrates the increase in the compressive strength of the blended cement containing reactive vaterite cement as a result of the accelerator additions. Accelerator additions were based on percent of cementitious material (CM).

TABLE III
Effect of alkali and alkaline earth metal accelerators
on blended cements containing reactive vaterite cement

| | 3-day Compressive | Strength |
|---|---|---|
| Mortar Mix | Strength (psi) | Increase (psi) |
| 60% Portland limestone cement, | 2630 | |
| 20% reactive vaterite cement, | | |
| & 20% calcined clay (CM) | | |
| +0.2 wt % Ca(NO₃)₂ of CM | 2920 | 290 |
| +0.5 wt % Ca(NO₃)₂ of CM | 2730 | 100 |
| +1 wt % Ca(NO₃)₂ of CM | 2860 | 230 |
| +0.2 wt % CaSO₄ of CM | 2890 | 260 |
| +0.5 wt % CaSO₄ of CM | 3130 | 500 |
| +1 wt % CaSO₄ of CM | 3170 | 540 |
| +0.2 wt % K₂O of CM | 2860 | 230 |
| +0.5 wt % K₂O of CM | 3350 | 720 |
| +1 wt % K₂O of CM | 3970 | 1340 |
| +0.2 wt % Na₂SO₄ of CM | 3640 | 1010 |
| +0.5 wt % Na₂SO₄ of CM | 3850 | 1220 |
| +1 wt % Na₂SO₄ of CM | 4480 | 1850 |
| +0.2 wt % Na₂CO₃ of CM | 3450 | 820 |
| +0.5 wt % Na₂CO₃ of CM | 4110 | 1480 |
| +1 wt % Na₂CO₃ of CM | 4510 | 1880 |

### Example 4

### Formation and Transformation of the Reactive Vaterite

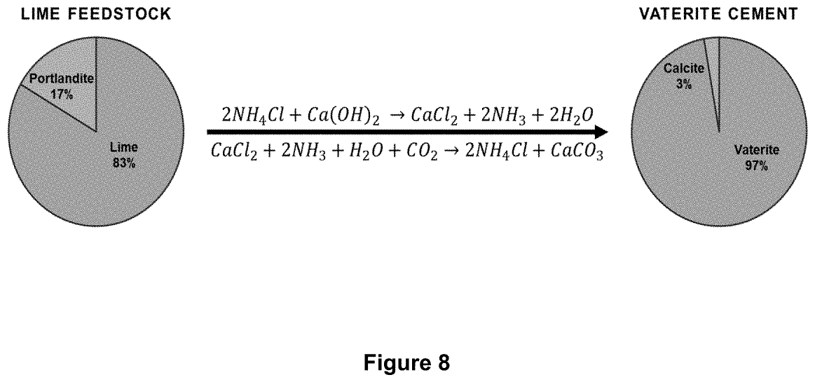

NH₄Cl is dissolved into water. Lime is added to the aqueous solution and mixed at 80° C. in a vessel with a vapor outlet tube. Vapor leaves the vessel through the outlet tube and is condensed along with CO₂ at 20° C. to form an aqueous solution containing ammonia, ammonium bicarbonate, and ammonium carbonate in a first airtight and collapsible bag. The solid and liquid mixture remaining in the vessel is cooled to 20° C. and vacuum filtered to remove the insoluble impurities. The clear CaCl₂-containing filtrate is transferred to a second airtight and collapsible bag. Both bags are submersed in a water bath, which preheats the solutions to 35° C. The precipitation reactor is an acrylic cylinder equipped with baffles, pH electrode, thermocouple, turbine impeller, and inlet and outlet ports for liquid feeds and product slurry. During startup, the CaCl₂-containing solution in the second bag is pumped into the reactor at a fixed flow rate. The mixer is stirred while the solution in the first bag is introduced by a separate pump. A computer automated control loop controls the continuous inlet flow of the ammonium carbonate-containing solution from the first bag maintaining the pH between 7-9. Reactive vaterite slurry is formed. The resultant reactive vaterite slurry is continuously collected into a holding container. The slurry is vacuum filtered. The reactive vaterite filter cake is oven dried at 100° C. The cake shows 100% vaterite with a mean particle size of 5 micron. The clear filtrate containing regenerated NH₄Cl is recycled in subsequent experiments. FIG. 8 illustrates an overall process and composition of the resulting reactive vaterite cement from lime feedstock.

The dried reactive vaterite solid is mixed with water into a paste. The XRD of the paste after 1 day shows 99.9% aragonite (vaterite fully converted to aragonite). The pastes are cast into 2″×2″×2″ cubes, which set and harden in a humidity chamber set to 60° C. and 80% of relative humidity for 7 days. The cemented cubes are dried in a 100° C. oven. Destructive testing determines the compressive strength of the cubes to be 4600 psi (˜31 MPa).

Although the foregoing invention has been described in some detail by way of illustration and example for purposes of clarity of understanding, it should be readily apparent to those of ordinary skill in the art in light of the teachings of this invention that certain changes and modifications may be made thereto without departing from the spirit or scope of the appended claims. Accordingly, the preceding merely illustrates the principles of the invention. It will be appreciated that those skilled in the art will be able to devise various arrangements, which, although not explicitly described or shown herein, embody the principles of the invention, and are included within its spirit and scope. Furthermore, all examples and conditional language recited herein are principally intended to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein. It is intended that the following claims define the scope of the invention and that methods and structures within the scope of these claims and their equivalents be covered thereby.

What is claimed is:

1. A cement blend composition, comprising: reactive vaterite cement and supplementary cementitious material (SCM) comprising aluminosilicate material.

2. The composition of claim 1, wherein the composition is a cement paste or cement slurry composition further comprising aragonite cement, calcite, carboaluminate hydrate, water, or combination thereof.

3. The composition of claim 1, wherein the reactive vaterite cement has a specific surface area of between about 100-10,000 m²/kg; the reactive vaterite cement has spherical particle shape having an average particle size of between about 0.1-100 μm; and/or the reactive vaterite cement further comprises magnesium oxide.

4. The composition of claim 1, wherein the reactive vaterite cement reacts with the aluminosilicate material to form carboaluminate hydrate comprising monocarboaluminate, hemicarboaluminate, or combination thereof.

5. The composition of claim 1, wherein the aluminosilicate material comprises heat-treated clay, natural or artificial pozzolan, shale, granulated blast furnace slag, or combination thereof.

6. The composition of claim 5, wherein the heat-treated clay comprises calcined clay, aluminosilicate glass, calcium aluminosilicate glass, or combination thereof.

7. The composition of claim 5, wherein the heat-treated clay is obtained from clay material or from the untreated clay material belonging to mineral selected from the group consisting of kaolin group, illite group, chlorite group, smectite group, vermiculite group, or mixture thereof.

8. The composition of claim 7, wherein the kaolin group comprises kaolinite, dickite, nacrite, halloysite, or mixture thereof; and/or the smectite group comprises dioctahedral smectite, trioctahedral smectite, or mixture thereof, wherein the dioctahedral smectite comprises montmorillonite and/or nontronite and/or the trioctahedral smectite comprises saponite.

9. The composition of claim 1, wherein the composition further comprises Portland cement clinker.

10. The composition of claim 1, wherein the SCM further comprises a carbonate material comprising limestone, calcium carbonate, magnesium carbonate, calcium magnesium carbonate, or combination thereof.

11. The composition of claim 1, wherein the composition further comprises alkali metal accelerator and/or an alkaline earth metal accelerator.

12. The composition of claim 11, wherein the alkali metal accelerator or the alkaline earth metal accelerator is selected from sodium sulfate, sodium carbonate, sodium nitrate, potassium sulfate, potassium carbonate, potassium nitrate, lithium sulfate, lithium carbonate, lithium nitrate, calcium sulfate, calcium nitrate, strontium sulfate, strontium carbonate, strontium nitrate, magnesium sulfate, magnesium carbonate, magnesium nitrate, potassium hydroxide, and combination thereof.

13. The composition of claim 1, comprising by weight between about 10-50% reactive vaterite cement and between about 10-35% aluminosilicate material comprising heat-treated clay, and further comprising between about 0-10% limestone, and between about 15-90% Portland cement clinker.

14. The composition of claim 13, further comprising between about 0.1-5% by weight gypsum.

15. A method of producing a cement blend composition, comprising:
(i) producing a reactive vaterite cement composition; and
(ii) blending a supplementary cementitious material (SCM) comprising aluminosilicate material with the reactive vaterite cement composition to produce a cement blend composition.

16. The method of claim 15, further comprising producing the reactive vaterite cement composition by (a) calcining limestone to form a mixture comprising lime and a gaseous stream comprising carbon dioxide; (b) dissolving the mixture comprising lime in a N-containing salt solution to produce an aqueous solution comprising calcium salt; and (c) treating the aqueous solution comprising calcium salt with the gaseous stream comprising carbon dioxide to form a composition comprising reactive vaterite cement.

17. The method of claim 15, further comprising producing the reactive vaterite cement composition by (a) dissolving limestone in a N-containing salt solution to produce an aqueous solution comprising calcium salt, and a gaseous stream comprising carbon dioxide; and (b) treating the aqueous solution comprising calcium salt with the gaseous stream comprising carbon dioxide to form a composition comprising reactive vaterite cement.

18. The method of claim 15, wherein the aluminosilicate material comprises heat-treated clay, natural or artificial pozzolan, shale, granulated blast furnace slag, or combination thereof.

19. The method of claim 18, further comprising heating a clay material at a temperature between 500-1100° C. to produce the heat-treated clay before the blending step (ii) and/or further comprising grinding the heat-treated clay.

20. The method of claim 15, further comprising mixing a carbonate material with the aluminosilicate material before the blending step (ii) and/or further comprising grinding the carbonate material to a specific surface area of 100-3,000 m²/kg before the mixing.

21. The method of claim 15, further comprising mixing Portland cement clinker with the aluminosilicate material before the blending step (ii).

22. The method of claim 15, further comprising adding water to the cement blend composition and transforming the reactive vaterite cement to aragonite cement and/or calcite upon dissolution and re-precipitation in water.

23. The method of claim 22, further comprising reacting the reactive vaterite cement with the aluminosilicate material to form carboaluminate hydrate comprising monocarboaluminate, hemicarboaluminate, or combination thereof.
